(19) United States
(12) Patent Application Publication
(10) Pub. No.: US 2019/0102169 A1
(43) Pub. Date: Apr. 4, 2019

(54) EFFECTIVE DETERMINATION OF PROCESSOR PAIRS FOR TRANSFERRING DATA PROCESSED IN PARALLEL

(71) Applicant: FUJITSU LIMITED, Kawasaki-shi (JP)

(72) Inventors: Masafumi Yamazaki, Tachikawa (JP); Tsuguchika TABARU, Machida (JP)

(73) Assignee: FUJITSU LIMITED, Kawasaki-shi (JP)

(21) Appl. No.: 16/137,618

(22) Filed: Sep. 21, 2018

(30) Foreign Application Priority Data
Sep. 29, 2017 (JP) 2017-191132

(51) Int. Cl. G06F 9/30; G06F 9/38; G06N 3/08

(52) U.S. Cl. CPC G06F 9/3001; G06N 3/08; G06F 9/3885

(57) ABSTRACT

An apparatus serves as at least one of a plurality of information processing devices each including a group of arithmetic processors, where the plurality of information processing devices are configured to perform parallel processing by using calculation result data of the groups of arithmetic processors included in the plurality of information processing devices. The apparatus includes a memory configured to store bandwidth information indicating a communication bandwidth with which an arithmetic processor included in the groups of arithmetic processors communicate with another arithmetic processor included in the groups of arithmetic processors. For a source arithmetic processor that is any one of the groups of arithmetic processors, the apparatus determines a destination arithmetic processor that is one of the groups of arithmetic processors to which the calculation result data of the source arithmetic processor is to be transferred, based on the bandwidth information stored in the memory.

### CROSS-REFERENCE TO RELATED APPLICATION

This application is based upon and claims the benefit of priority of the prior Japanese Patent Application No. 2017-191132, filed on Sep. 29, 2017, the entire contents of which are incorporated herein by reference.

### FIELD

The embodiments discussed herein are related to effective determination of processor pairs for transferring data processed in parallel.

### BACKGROUND

In a system which has introduced the Deep Learning, learning processing is performed in which, for instance, vast quantities of data are repeatedly learned. Thus, the amount of calculation of the learning processing in a system which has introduced the Deep Learning is significantly large. At present, when a system which has introduced the Deep Learning is used in a field such as image identification, for instance, a million or more still images each with a label for learning are repeatedly learned. Therefore, a system including an arithmetic processor, such as a graphical processing unit (GPU), having more product-sum operation units than a normal central processing unit (CPU) and capable of performing high-speed calculation used for learning processing is utilized or a cluster environment combining multiple nodes each including the arithmetic processor is utilized.

In short, utilization of an arithmetic processor such as a GPU is effective for learning processing, and high-speed processing is further achieved by performing processing with the processing distributed across multiple arithmetic processors. Methods of performing processing with the processing distributed across multiple arithmetic processors include, for instance, in-node parallel processing in which processing is distributed across multiple arithmetic processors mounted in a node, and inter-node parallel processing in which processing is distributed across respective arithmetic processors mounted in multiple nodes.

Meanwhile, in learning processing of Deep Learning, for instance, forward processing for making recognition from input data, backward processing for obtaining gradient information while transmitting difference information between a calculation result and correct answer data in a reverse direction, and update processing for updating a weight coefficient using the gradient information are repeatedly performed. When parallel processing is performed between multiple arithmetic processors, All-Reduce processing is further performed in which an average of the gradient information on the arithmetic processors is calculated using the gradient information calculated in each of the arithmetic processors, and the average of the gradient information is shared again by all the arithmetic processors. That is, in the in-node parallel processing and the inter-node parallel processing, the forward processing, the backward processing, the All-Reduce processing, and the update processing are repeatedly performed.

Related techniques are disclosed in, for example, Japanese Laid-open Patent Publication No. 11-134311 and International Publication Pamphlet No. WO 2014/020959.

### SUMMARY

According to an aspect of the invention, an apparatus serves as at least one of a plurality of information processing devices each including a group of arithmetic processors, where the plurality of information processing devices are configured to perform parallel processing by using calculation result data of the groups of arithmetic processors included in the plurality of information processing devices. The apparatus includes a memory configured to store bandwidth information indicating a communication bandwidth with which an arithmetic processor included in the groups of arithmetic processors communicate with another arithmetic processor included in the groups of arithmetic processors. For a source arithmetic processor that is any one of the groups of arithmetic processors, the apparatus determines a destination arithmetic processor that is one of the groups of arithmetic processors to which the calculation result data of the source arithmetic processor is to be transferred, based on the bandwidth information stored in the memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating example processing in a neural network;

FIG. 2 is a diagram illustrating example learning processing when multiple GPUs are used;

FIG. 3 is a diagram illustrating an example algorithm of the Butterfly method;

FIG. 4 is a diagram illustrating an example algorithm of the Halving/Doubling method;

FIG. 5 is an example of a comparison table between the Butterfly method and the Halving/Doubling method;

FIG. 6 is a diagram illustrating an example of a system configuration and a hardware configuration of nodes in a deep learning system according to a first embodiment;

FIG. 7 is an example flowchart of learning processing of deep learning in a node;

FIG. 8 is an example flowchart of acquisition processing for connection bandwidth information on a node;

FIG. 9 is an example flowchart of transfer pair determination processing;

FIG. 10 is an example flowchart of All-Reduce processing;

FIG. 11 is a diagram illustrating a system configuration of a deep learning system according to Specific Example 1;

FIG. 12 is a table illustrating example connection bandwidth information in Specific Example 1;

FIG. 13 is a table illustrating example transfer pairs in step 1 of All-Reduce processing in Specific Example 1;

FIG. 14 is a table illustrating example transfer pairs in step 2 of the All-Reduce processing in Specific Example 1;

FIG. 15 is a table illustrating example transfer pairs in step 3 of the All-Reduce processing in Specific Example 1;

FIG. 16 is a table illustrating an example combination of transfer pairs in Halving/Doubling method in Specific Example 1;

FIG. 17 is a table illustrating an example variation in combination of transfer pairs in each of step 1 and step 2 illustrated in FIG. 16;

FIG. 18 is a table illustrating an example variation in transfer pairs in step 3 illustrated in FIG. 16;

FIG. 19 is a diagram illustrating a system configuration of a deep learning system according to Specific Example 2;

FIG. 20 is a table illustrating example connection bandwidth information in Specific Example 2;

FIG. 21 is a table illustrating example transfer pairs in step 1 of All-Reduce processing in Specific Example 2;

FIG. 22 is a table illustrating example transfer pairs in step 2 of the All-Reduce processing in Specific Example 2;

FIG. 23 is a table illustrating example transfer pairs in step 3 of the All-Reduce processing in Specific Example 2;

FIG. 24 is a table illustrating an example combination of transfer pairs in Halving/Doubling method in Specific Example 2;

FIG. 25 is a table illustrating an example variation in transfer pairs in step 2 illustrated in FIG. 24;

FIG. 26 is a table illustrating example connection bandwidth information in Specific Example 3;

FIG. 27 is a table illustrating example transfer pairs in step 1 of All-Reduce processing in Specific Example 3;

FIG. 28 is a table illustrating example transfer pairs in step 2 of the All-Reduce processing in Specific Example 3;

FIG. 29 is a table illustrating example transfer pairs in step 3 of the All-Reduce processing in Specific Example 3;

FIG. 30 is a table illustrating an example combination of transfer pairs in Halving/Doubling method in Specific Example 3;

FIG. 31 is a table illustrating an example variation in combination of transfer pairs in each of step 1 and step 2 illustrated in FIG. 30;

FIG. 32 is a diagram illustrating an example hardware configuration of nodes according to a first modification; and

FIG. 33 is an example flowchart of learning processing of deep learning in a node according to a second modification.

### DESCRIPTION OF EMBODIMENTS

When the number of arithmetic processors and/or nodes increases, the time taken for All-Reduce processing to exchange data between the arithmetic processors also increases. In addition, transmission speed varies between the arithmetic processors and between the nodes, and thus the time taken for processing varies depending on an algorithm for the All-Reduce processing and a pattern of pairs for data exchange.

It is preferable to achieve high-speed parallel processing performed by multiple arithmetic processors.

Hereinafter, an embodiment of the disclosure will be described with reference to the drawings. The configuration of the embodiment below is an example, and the present disclosure is not limited to the configuration of the embodiment.

<Processing Example of Deep Learning>

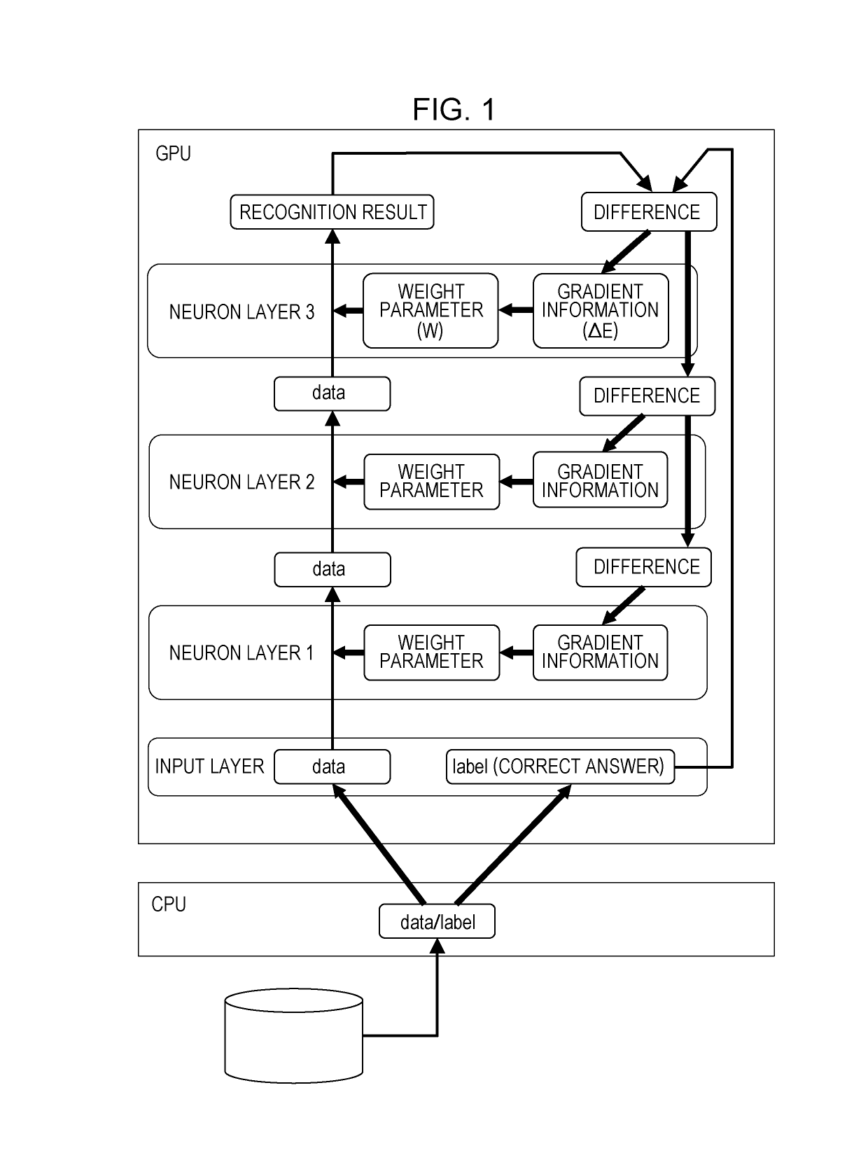

FIG. 1 is a diagram illustrating example processing in a neural network. FIG. 1 illustrates a neural network including an input layer and three neuron layers. Also, FIG. 1 illustrates learning processing when a single GPU is utilized. FIG. 1 exemplifies a deep learning system.

In learning processing in a neural network, a weight parameter w for each of neuron layers is adjusted so that, for instance, the difference between a calculation result and correct answer data in the neural network is reduced. Thus, predetermined calculation processing is first performed in each neuron layer using the weight parameter w, for instance, for input data, and calculation result data is outputted. In the example illustrated in FIG. 1, output data from the input layer serves as input data to a neuron layer 1, calculation result data from the neuron layer 1 serves as input data to a neuron layer 2, and calculation result data from the neuron layer 2 serves as input data to a neuron layer 3. The calculation result data from the neuron layer 3 provides a recognition result. The processing that proceeds in the direction from the input layer to the neuron layer 3 is referred to as forward processing.

The difference information (error E) between the calculation result data from the neuron layer 3 and correct answer data is transmitted in a reverse direction from the neuron layer 3 to the neuron layer 2, and from the neuron layer 2 to the neuron layer 1. In each neuron layer, gradient information (∇E), which is an amount of change in the error E, is determined based on the transmitted difference information. The processing that proceeds in the direction from the neuron layer 3 to the neuron layer 1 is referred to as backward processing.

In each neuron layer, a weight parameter is updated using the gradient information (∇E). The processing is referred to as update processing. In learning processing in a neural network, processing is repeatedly performed in the order of the forward processing, the backward processing, and the update processing, and the weight parameter w of each neuron layer is adjusted so that the difference information between the calculation result data from the neuron layer 3 and correct answer data is reduced. The processing performed in the order of the forward processing, the backward processing, and the update processing is referred to as a learning processing cycle.

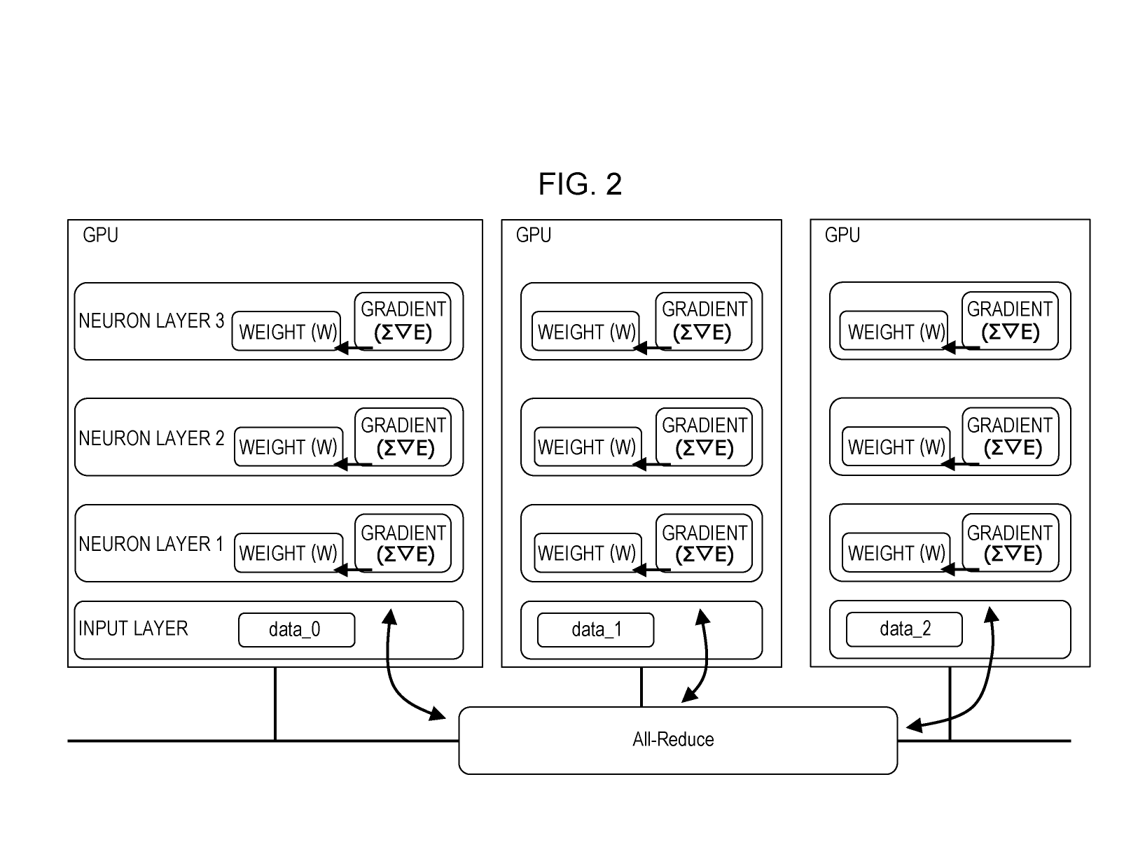

FIG. 2 is a diagram illustrating example learning processing when multiple GPUs are used. In FIG. 2, each of the GPUs performs processing for three neuron layers. In other words, FIG. 2 also exemplifies a deep learning system.

Types of learning processing that uses multiple GPUs include batch learning, for instance. In the batch learning, a learning processing cycle is executed in the multiple GPUs for different sets of learning data, and the weight parameter w of each neuron layer in each of the GPUs is updated using an average value (Σ∇E/n, where n is the number of GPUs) of gradient information (∇E) calculated in each GPU.

FIG. 2 illustrates an example when the batch learning is performed as the learning method. Since an average value (Σ∇E/n, where n is the number of GPUs) of gradient information (∇E) calculated in the GPUs is used when the batch learning is performed, All-Reduce processing is performed in which the gradient information (∇E) calculated in the GPUs is aggregated, and the aggregated gradient information is shared between the GPUs. Therefore, the learning processing cycle when the batch learning is performed in a learning processing using multiple GPUs is executed in the order of the forward processing, the backward processing, the All-Reduce processing, and the update processing.

Algorithms for the All-Reduce processing include, for instance, the Butterfly method, and the Halving/Doubling method.

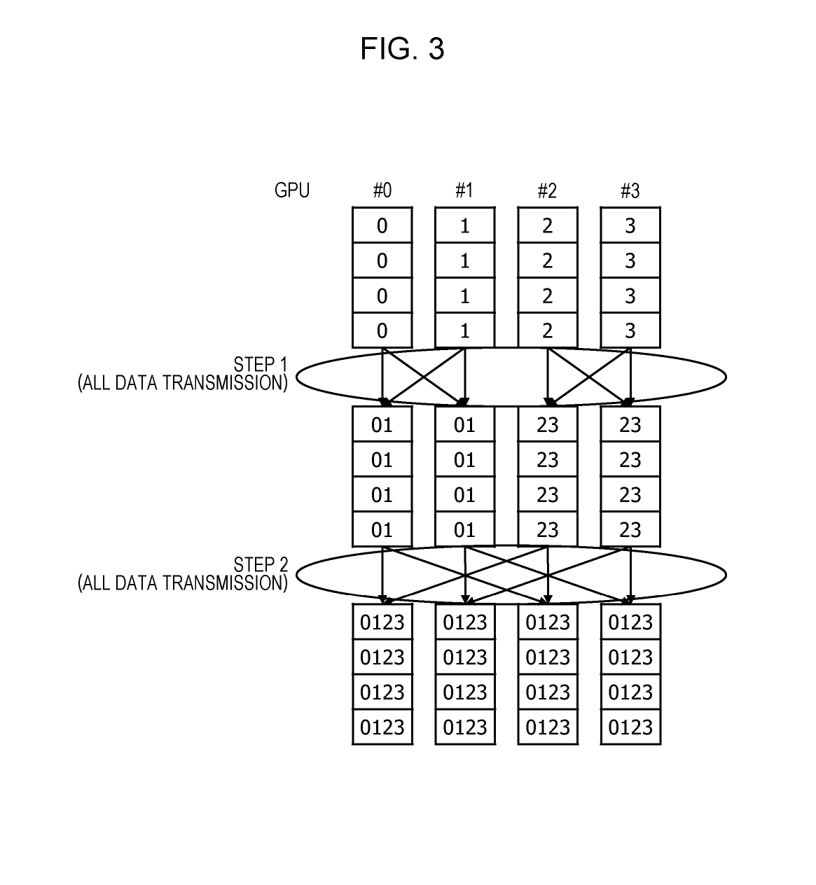

FIG. 3 is a diagram illustrating an example algorithm in the Butterfly method. FIG. 3 illustrates an example in which gradient information (∇E) of four neuron layers is aggregated and shared between four GPUs.

The Butterfly method is such a method that makes pairs of nodes, and performs a step of transferring all data between the nodes in each pair, multiple times. Note that the GPUs are nodes in FIG. 3. Hereinafter, pairs of nodes are also referred to as “transfer pairs”.

In the example illustrated in FIG. 3, in the first step, GPU #0 and GPU #1, and GPU #2 and GPU #3 form a pair, and transfer data to each other. Hereinafter, Xth step is simply denoted by step X.

When step 1 is completed, in each neuron layer included in GPU #0 and GPU #1, the gradient information on GPU #0 and GPU #1 is held. In each neuron layer included in GPU #2 and GPU #3, the gradient information on GPU #2 and GPU #3 is held.

In step 2, pairs are each formed between different GPUs from the GPUs in step 1, and data is transferred. In the example illustrated in FIG. 3, in step 2, GPU #0 and GPU #2, and GPU #1 and GPU #3 form pairs, and transfer data to each other. When step 2 is completed, in each neuron layer included in GPU #0 to GPU #3, the gradient information on GPU #0 to GPU #1 is held, and aggregation and sharing of the gradient information on each GPU are completed.

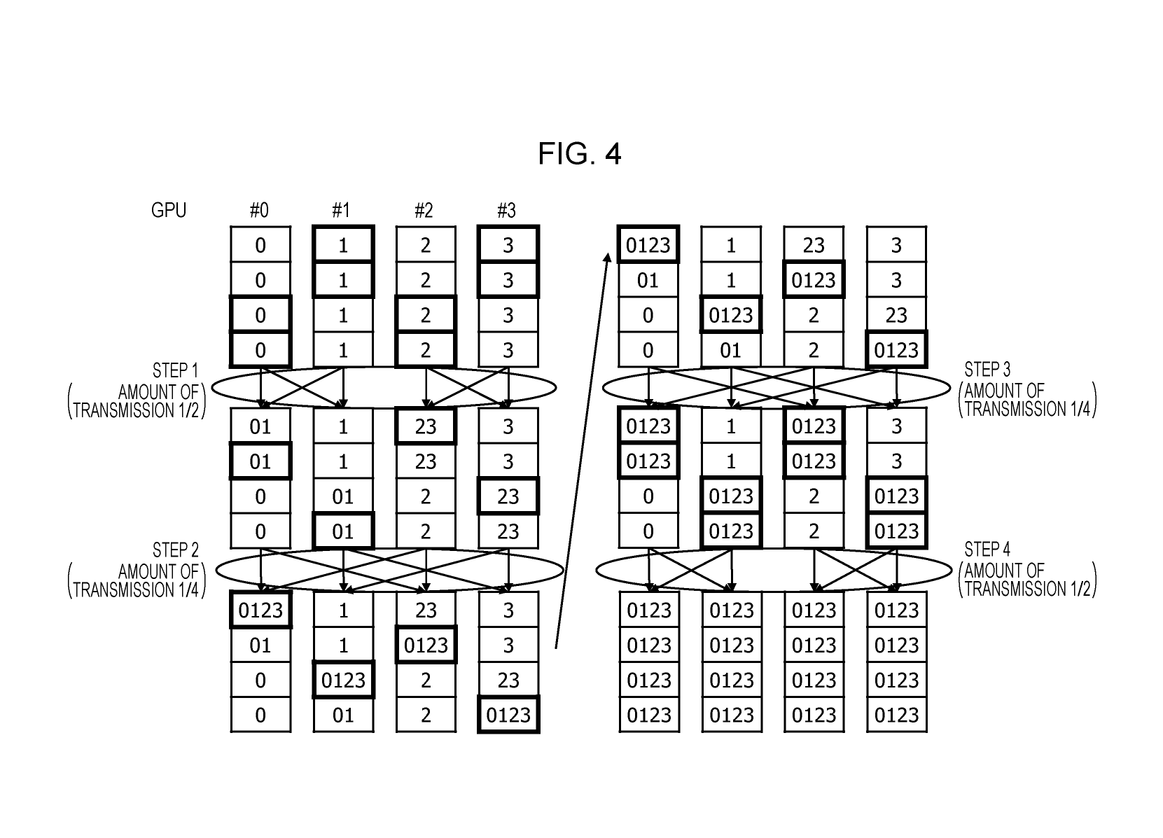

FIG. 4 is a diagram illustrating an example algorithm in the Halving/Doubling method. Similarly to FIG. 3, FIG. 4 illustrates an example in which gradient information (∇E) of four neuron layers is aggregated and shared between four GPUs.

The Halving/Doubling method is such a method that performs inter-node communication and aggregation processing so that the nodes each have an aggregation result for M/N (M is a data size, and N is the number of GPUs), and subsequently, aggregated data is shared between all the nodes. Note that the GPUs are nodes in FIG. 4.

In the example illustrated in FIG. 4, in step 1, GPU #0 and GPU #1, and GPU #2 and GPU #3 form pairs, and transfer data of neuron layers with half different to each other between each pairs. When step 1 is completed, in GPU #0 and GPU #1, the gradient information on GPU #0 and GPU #1 is held in different half neuron layers among the neuron layers. In GPU #2 and GPU #3, the gradient information on GPU #2 and GPU #3 is held in different half neuron layers among the neuron layers.

In step 2, pairs are each formed between different GPUs from the GPUs in step 1, and half of the data of neuron layers having the data of the other member of each pair formed in step 1, in other words, quarter of the data of the neuron layers is transferred. In the example illustrated in FIG. 4, in step 2, GPU #0 and GPU #2, and GPU #1 and GPU #3 form pairs, and transfer data with quarter different to each other between each pair. When step 2 is completed, in each of GPU #0 to GPU #3, the gradient information on GPU #0 to GPU #3 is held in one different layer between the four neuron layers.

In the example illustrated in FIG. 4, after completion of step 2, in each of the four neuron layers, aggregation of the gradient information on GPU #0 to GPU #3 is completed. Therefore, in step 3 and after, processing to share the aggregated gradient information on GPU #0 to GPU #3 is performed. The sharing processing to share the aggregated gradient information on GPU #0 to GPU #3 is performed, for instance, in the reverse order of the aggregation processing (step 1 and step 2 in FIG. 4).

In step 3, for instance, the same pairs as in step 2 are formed, and gradient information of one neuron layer including the aggregated gradient information on GPU #0 to GPU #3 is transferred. Since the gradient information on one neuron layer including the aggregated gradient information on GPU #0 to GPU #3 is information of one neuron layer between the four neuron layers, the data volume transmitted in step 3 is one fourth of the entire data.

In the example illustrated in FIG. 4, in step 3, for instance, GPU #0 and GPU #2, and GPU #1 and GPU #3 form pairs, and transfer the gradient information on one neuron layer including the aggregated gradient information on GPU #0 to GPU #3 to each other. When step 3 is completed, in each of GPU #0 to GPU #3, a state is achieved where the gradient information on GPU #0 to GPU #3 is held in two neuron layers between the four neuron layers.

In step 4, for instance, the same pairs as in step 1 are formed, and gradient information of two neuron layers including the aggregated gradient information on GPU #0 to GPU #3 is transferred. Since the gradient information on two neuron layers including the aggregated gradient information on GPU #0 to GPU #3 is information of two neuron layers between the four neuron layers, the data volume transmitted in step 4 is one half of the entire data.

In the example illustrated in FIG. 4, in step 4, GPU #0 and GPU #1, and GPU #2 and GPU #3 form pairs, and transfer the gradient information on two neuron layers including the aggregated gradient information on GPU #0 to GPU #3 to each other. When step 4 is completed, in each of GPU #0 to GPU #3, a state is achieved where the gradient information on GPU #0 to GPU #3 is held in all the four neuron layers.

Note that in the Halving/Doubling method, in the processing (the steps in step 3 and after in FIG. 4) to share the gradient information on all GPUs after the gradient information on all GPUs is aggregated, a pair of transfer destinations may be formed in any manner. For instance, in step 3 of FIG. 4, GPU #0 and GPU #1, and GPU #2 and GPU #3 may form pairs, and in step 4, GPU #0 and GPU #2, and GPU #1 and GPU #3 may form pairs.

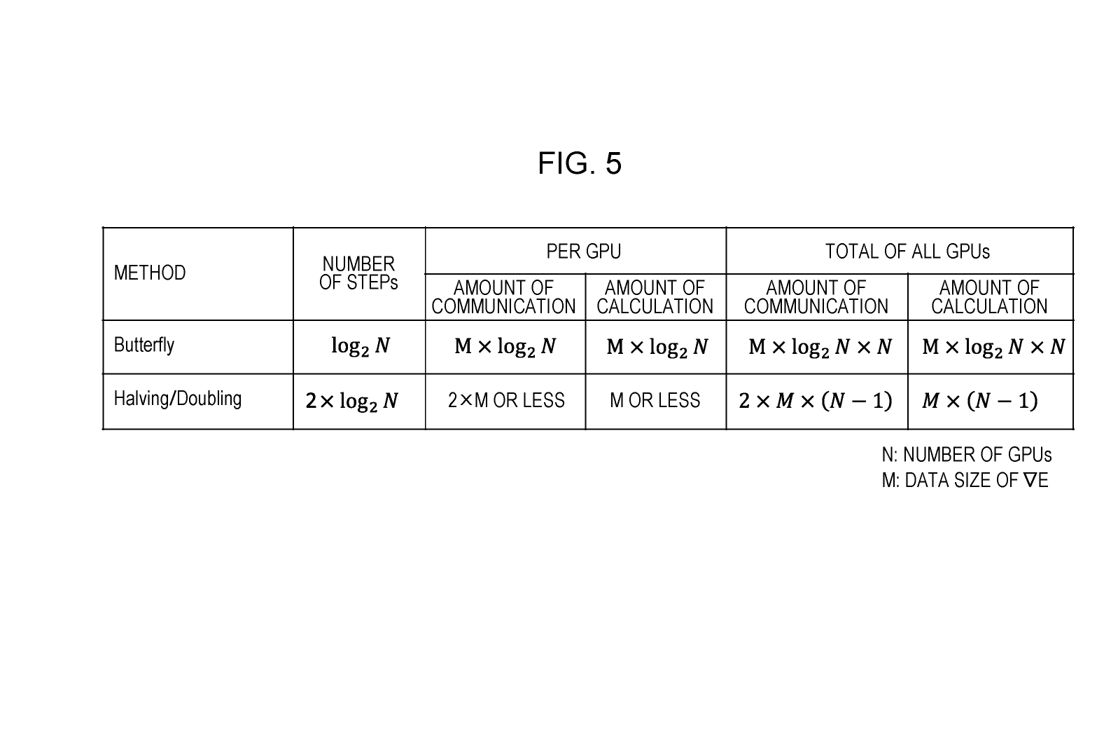

FIG. 5 is an example of a comparison table between the Butterfly method and the Halving/Doubling method. Here, N is the number of GPUs and M is the data size of gradient information (∇E). In the Butterfly method, the number of steps is log[2] N (where [ ] indicates the base of the logarithm), the communication volume and the calculation amount per GPU are each M×log[2]N, and the total of the communication volume and the calculation amount for all GPUs is M×log[2] (N×N). In the Halving/Doubling method, the number of steps is 2×log[2] N, the communication volume per GPU is 2×M or less, the calculation amount per GPU is M or less, the total of the communication volumes for all GPUs is 2×M×(N−1), and the total of the calculation amounts for all GPUs is M×(N−1).

The Butterfly method has a less number of steps, however, has larger communication volume and calculation amount for the entire system because all GPUs perform aggregation processing by exchanging all data. Therefore, the Butterfly method provides an effective algorithm when it is possible to perform high-speed aggregation calculation processing or when the size of data to be transferred is small.

The Halving/Doubling method has a greater number of steps, however, has smaller communication volume and calculation amount. Therefore, the Halving/Doubling method provides an effective algorithm when the number of GPUs is large or when the size of data to be transferred is large.

Determining which algorithm is more effective depends on the conditions such as the number of GPUs, a data size, a communication bandwidth, and a connection relationship between the GPUs. An algorithm for the All-Reduce processing and transfer pairs in each step in the algorithm are pre-set. Therefore, it is possible to achieve high-speed All-Reduce processing, eventually, high-speed learning processing of deep learning by setting an algorithm according to the conditions, such as the number of GPUs, a data size, a communication bandwidth, and a connection relationship between the GPUs, and transfer pairs in each step of the algorithm. Note that the algorithm for the All-Reduce processing is not limited to the Butterfly method and the Halving/Doubling method.

Note that the number of GPUs that perform learning processing is not limited to the Nth power of 2, and may be an even number other than the Nth power of 2 or an odd number. For instance, when the number of GPUs is the Nth power of 2+X (1≤X<the Nth power of 2), X pairs of GPUs are formed, and all data is first transferred between the X pairs. Subsequently, the X pairs are each regarded as one GPU, and the All-Reduce processing is performed on the X GPUs (X pairs) and (the Nth power of 2−X) GPUs which are (the Nth power of 2) pairs. After the All-Reduce processing is completed, all data is exchanged between the X pairs. Therefore, when the number of the arithmetic processors that perform learning processing is not the Nth power of 2, the number of steps to achieve aggregation is two more than the number of steps when the number of the arithmetic processors is the Nth power of 2.

For instance, when 7 sets of GPUs #0 to #6 are provided (7=the 2nd power of 2+3, N=2, X=3), first, all data is transferred between 3 (=X) pairs: GPU #0 and GPU #1, GPU #2 and GPU #3, and GPU #4 and GPU #5. Then, GPU #0 (0, 1) may be representative of GPU #0 and GPU #1, GPU #2 (2, 3) may be representative of GPU #2 and GPU #3, and GPU #4 (4, 5) may be representative of GPU #4 and GPU #5. The inside of parentheses also indicates the data of other GPU held by each GPU.

Next, the All-Reduce processing may be performed among GPU #0 (0, 1), GPU #2 (2, 3), GPU #4 (4, 5), and GPU #6 (6). Any one of the Butterfly method and the Halving/Doubling method allows an aggregation result for all the nodes to be obtained in GPU #0, GPU #2, GPU #4, and GPU #6 by the All-Reduce processing.

Finally, a result of the All-Reduce processing may be transferred, for instance, from GPU #0 to GPU #1, from GPU #2 to GPU #3, and from GPU #4 to GPU #5. However, in the case of the Halving/Doubling method, data transfer between 3 (=X) pairs of GPU #0 and GPU #1, GPU #2 and GPU #3, and GPU #4 and GPU #5, and data transfer performed finally from GPU #0 to GPU #1, from GPU #2 to GPU #3, and from GPU #4 to GPU #5 have the largest data volume. Therefore, it is desirable to ensure a largest bandwidth between the pairs in which data transfer is performed first and last.

### First Embodiment

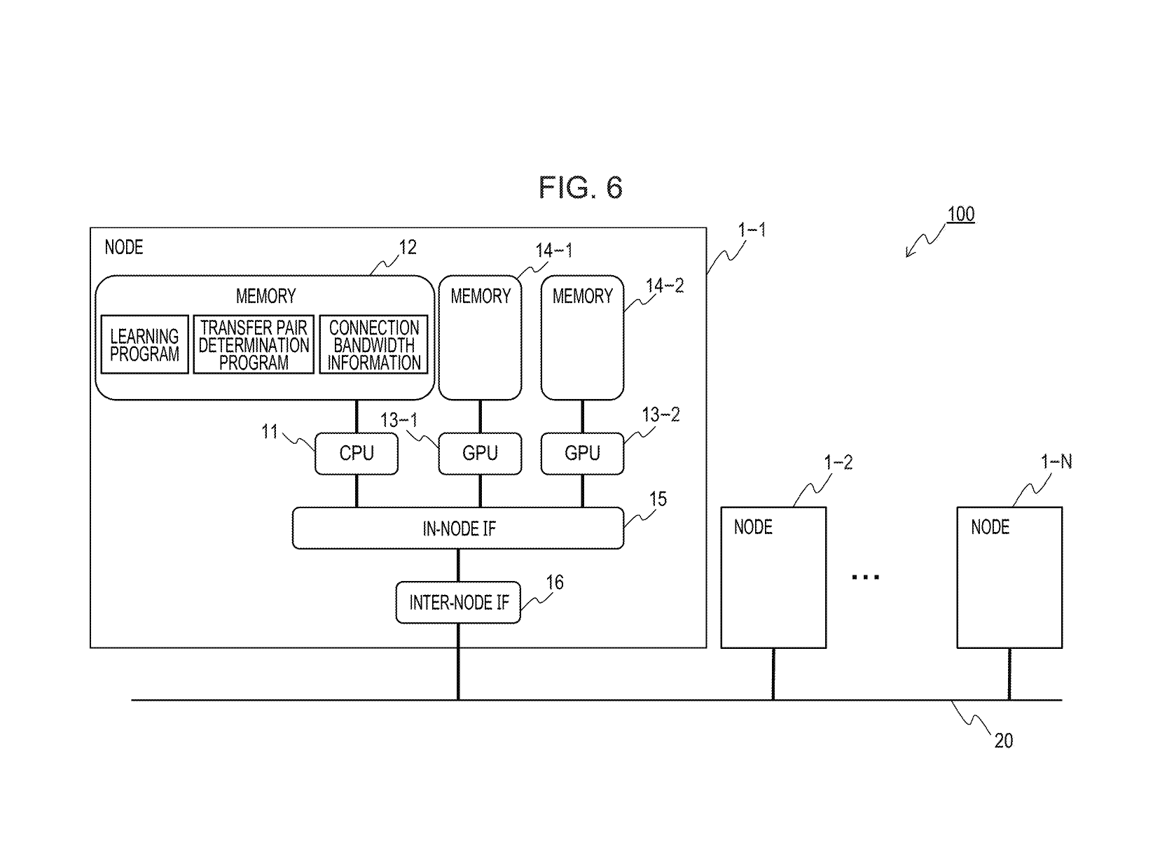

FIG. 6 is a diagram illustrating an example of a system configuration and a hardware configuration of nodes in a deep learning system 100 according to a first embodiment. The deep learning system 100 according to the first embodiment includes multiple nodes 1. The nodes 1, when distinguished from each other, are denoted as nodes 1-1, 1-2, and . . . 1-N. The nodes 1, when not distinguished from each other, are simply denoted as the node 1. In the first embodiment, the number of nodes 1 is not particularly limited. The deep learning system 100 is an example of the “information processing system”. The node 1 is an example of the “information processing device”.

The nodes 1 are coupled via a high-speed inter-node network 20. The high-speed inter-node network 20 is called, for instance, a crossbar, an interconnect, or the like. Note that the high-speed inter-node network 20 may have any network configuration. For instance, the high-speed inter-node network 20 may be a mesh in the torus structure, or a bus network like a local area network (LAN).

In the first embodiment, one of the nodes 1 in the deep learning system 100 determines an algorithm to be used for the All-Reduce processing and transfer pairs of GPUs in each step of the algorithm, and notifies other nodes 1 of the algorithm and the transfer pairs. In the first embodiment, an algorithm to be used for the All-Reduce processing and transfer pairs of GPUs in each step of the algorithm are determined based on the communication bandwidths between the GPUs included in the nodes 1. The GPU is an example of the “arithmetic processor”. The other GPU in a transfer pair is an example of the “destination arithmetic processor” which is an arithmetic processor at a transfer destination. The transfer pair is an example of the “pair between which the calculation result data is transferred”.

In the All-Reduce processing in a learning processing cycle, each node 1 transfers gradient information to a GPU at a transfer destination in accordance with the notified algorithm and transfer pairs in each step. The gradient information is an example of the “calculation result data”.

The node 1 is, for instance, a supercomputer, a general-purpose computer, or a dedicated computer. The node 1 includes, as the hardware components, a central processing unit (CPU) 11, a memory 12 for CPU, multiple GPUs 13, and multiple memories 14 for GPU. The CPU 11 and each GPU 13 are coupled via an in-node interface (IF) 15. In addition, the CPU 11 and each GPU 13 are coupled to an inter-node IF 16 via the in-node IF 15. The GPUs 13, when not distinguished from each other, are simply denoted as the GPU 13. In the first embodiment, the CPU 11 is an example of the “processing unit”. In the first embodiment, the memory 12 is an example of the “storage unit”.

The CPU 11 performs and the processing of the node 1, such as communication processing with another node 1 or processing to control and manage each GPU 13, in accordance with a computer program loaded in the memory 12 in an executable manner. The CPU 11 is also called a microprocessor (MPU) or a processor. The CPU 11 is not limited to a single processor, and may have a multi-processor configuration. Alternatively, a single CPU 11 coupled via a single socket may have a multi-core configuration. At least part of the processing of the CPU 11 may be performed by a processor other than the CPU 11, for instance, by one of the GPUs 13.

The memory 12 is, for instance, a random access memory (RAM). The memory 12 stores computer programs to be executed by the CPU 11 and data to be processed by the CPU 11. For example, the memory 12 stores a learning program, a transfer pair determination program, and connection bandwidth information. The learning program is a program for causing each GPU 13 to perform the learning processing of deep learning. The transfer pair determination program is a program for determining an algorithm for the All-Reduce processing in a learning processing cycle, and transfer pairs for gradient information in each step. The transfer pair determination program may be, for instance, one of the modules included in the learning program.

The connection bandwidth information is information on the communication bandwidths between the GPUs 13 in the deep learning system 100. The details of the connection bandwidth information will be described later. Note that the programs stored in the memory 12 are not limited to the learning program and the transfer pair determination program. For instance, the memory 12 also stores a program for inter-node communication. The connection bandwidth information is an example of the “bandwidth information”.

The GPU 13 includes, for instance, multiple high-speed video RAMs (VRAM) and multiple high-speed calculation units, and performs a high-speed product-sum operation or the like. The GPU 13 performs, for instance, learning processing out of the processing of the node 1, in accordance with a computer program loaded in the memory 14 in an executable manner. The GPU 13 is a kind of an accelerator. An accelerator of another type may be used instead of the GPU 13.

The memory 14 is, for instance, a RAM. The memory 14 stores computer programs to be executed by the GPU 13 and data to be processed by the GPU 13. The memory 14 may be included in each GPU 13, or a divided area in one memory 14 may be allocated to each GPU 13.

At least part of the processing of the CPU 11 and each GPU 13 may be performed by a dedicated processor such as a digital signal processor (DSP), a numerical processor, a vector processor, and an image processing processor. Also, at least part of the processing of the above-mentioned units may be performed by an integrated circuit (IC), or other digital circuits. Also, at least part of the above-mentioned units may include an analog circuit. The integrated circuit includes an LSI, an application specific integrated circuit (ASIC), and a programmable logic device (PLD). The PLD includes, for instance, a field-programmable gate array (FPGA).

In other words, at least part of the processing of the CPU 11 or the GPU 13 may be performed by a combination of a processor and an integrated circuit. The combination is called, for instance, a micro controller (MCU), a system-on-a-chip (SoC), a system LSI, or a chip set.

The in-node IF 15 is coupled, for instance, to an internal bus of the CPU 11 and each GPU 13, and couples the CPU 11 and the GPU 13 to each other. Also, the in-node IF 15 couples the CPU 11 and each GPU 13 to the inter-node IF 16. The in-node IF 15 is, for instance, a bus in conformity with the standard of PCI-Express.

The inter-node IF 16 is an interface that couples the node 10 to each other via the high-speed inter-node network 20.

Communication between the GPUs 13 in the node 1 is performed, for instance, by each GPU 13 executing software such as the NVIDIA Collective Communications Library (NCCL). For communication between the nodes 1, for instance, a message passing interface (MPI) is used. For communication between the nodes 1 is performed, for instance, by the CPU 11 of one node 1 executing a program for MPI. Hereinafter, communication between the GPUs 13 in the node 1 is referred to as in-node communication. Also, communication between the GPUs 13 in different nodes 1 is referred to as inter-node communication.

<Flow of Processing>

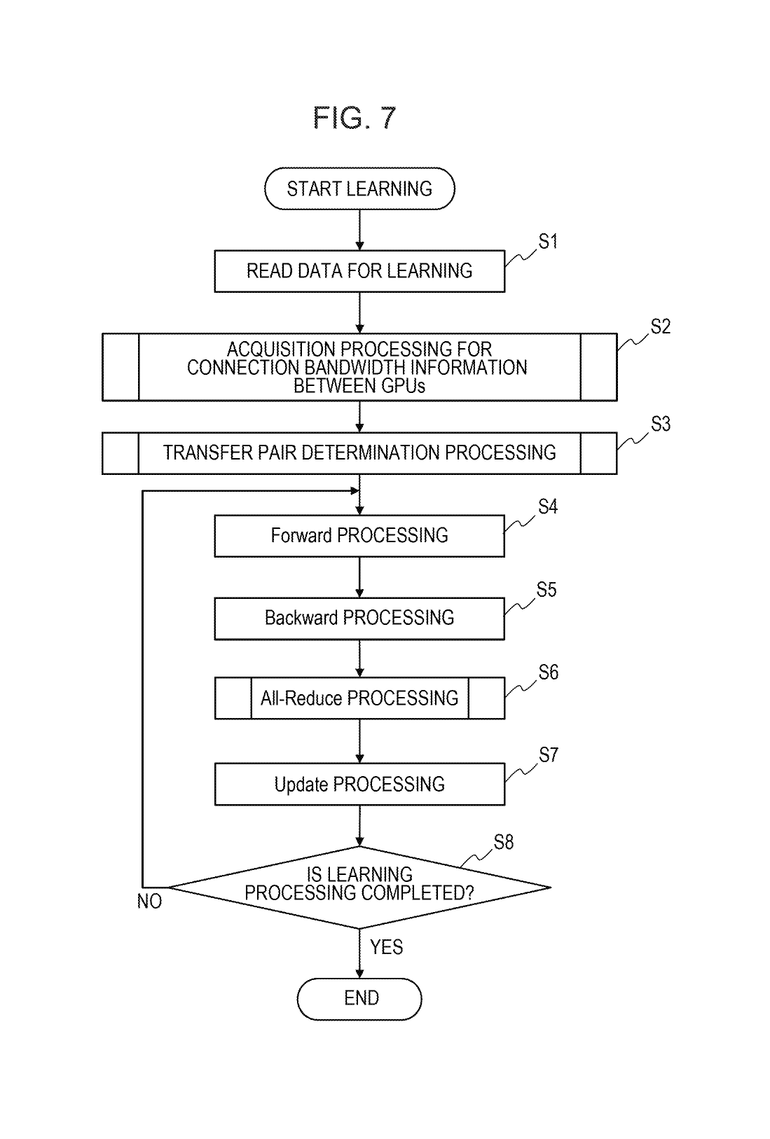

FIG. 7 is an example flowchart of learning processing of deep learning in the node 1. The processing illustrated in FIG. 7 is processing implemented, for instance, by the CPU 11 of the node 1 executing the learning program. The processing illustrated in FIG. 7 is to be performed by each node 1 in the deep learning system 100. In the drawings used in the description below, a neuron layer N is denoted as a Layer N.

The processing illustrated in FIG. 7 is started, for instance, by input of an instruction to start learning. An instruction to start learning is inputted by an administrator of the deep learning system 100, for instance, via a control device that controls all nodes 1 in the deep learning system 100 or via one of the nodes 1.

The CPU 11 reads data for learning (S1). The data for learning is read from, for instance, a storage device of a hard disk or the like in the node 1 or an external storage device of the node 1. Subsequently, the CPU 11 performs processing to acquire connection bandwidth information between the GPUs 13 (S2). The connection bandwidth information between the GPUs 13 is acquired by the acquisition processing for connection bandwidth information. The details of the acquisition processing for connection bandwidth information will be described later.

Subsequently, the CPU 11 performs transfer pair determination processing (S3). In the transfer pair determination processing, an algorithm for the All-Reduce processing and transfer pairs in each step of the algorithm are determined so that the time taken for the All-Reduce processing is reduced, and the algorithm and the transfer pairs are shared among the nodes 1. The details of the transfer pair determination processing will be described later. Note that in the first embodiment, the node 1 that performs the transfer pair determination processing is one of the nodes 1 in the deep learning system 100. Therefore, when the node 1 is a node that does not perform the transfer pair determination processing, the node 1 does not perform the transfer pair determination processing in S3, and is notified of an algorithm for the All-Reduce processing and transfer pairs in each step of the algorithm from another node 1.

Subsequently, the CPU 11 starts learning processing of each GPU 13. The processing in S4 to S7 is learning processing. The processing in S4, S5, and S7 is performed by each GPU 13. Each GPU 13 sequentially performs the forward processing in all the neuron layers (from a neuron layer 1 to a neuron layer N) (S4). Subsequently, each GPU 13 sequentially performs the backward processing in all the neuron layers (from the neuron layer N to the neuron layer 1) (S5).

Subsequently, the All-Reduce processing is performed (S6). The details of the All-Reduce processing will be described later. The gradient information calculated by each GPU 13 is shared among all GPUs 13 in the deep learning system 100 by the All-Reduce processing. Note that for the All-Reduce processing, communication (in-node communication) between the GPUs 13 in the node 1 is performed by the GPU 13 (such as the NCCL), and communication (inter-node communication) between the GPUs 13 included in different nodes 1 is performed via the CPU 11 (such as an MPI).

Subsequently, each GPU 13 performs update processing to update a weight parameter, based on the average value of the gradient information (S7). Subsequently, each GPU 13 determines whether or not repetition of learning processing is ended (S8). Here, for instance when learning of target learning data is not converged or a predetermined number of times of learning processing is not reached, each GPU 13 returns the processing to S4, and repeatedly performs the learning processing cycle (NO in S8). On the other hand, when learning of target learning data is converged and a predetermined number of times of learning processing is reached, each GPU 13 completes the learning processing cycle, and completes the processing illustrated in FIG. 7 (YES in S8). That learning is converged indicates that the gradient information approaches 0 in a predetermined range of acceptable value, for instance.

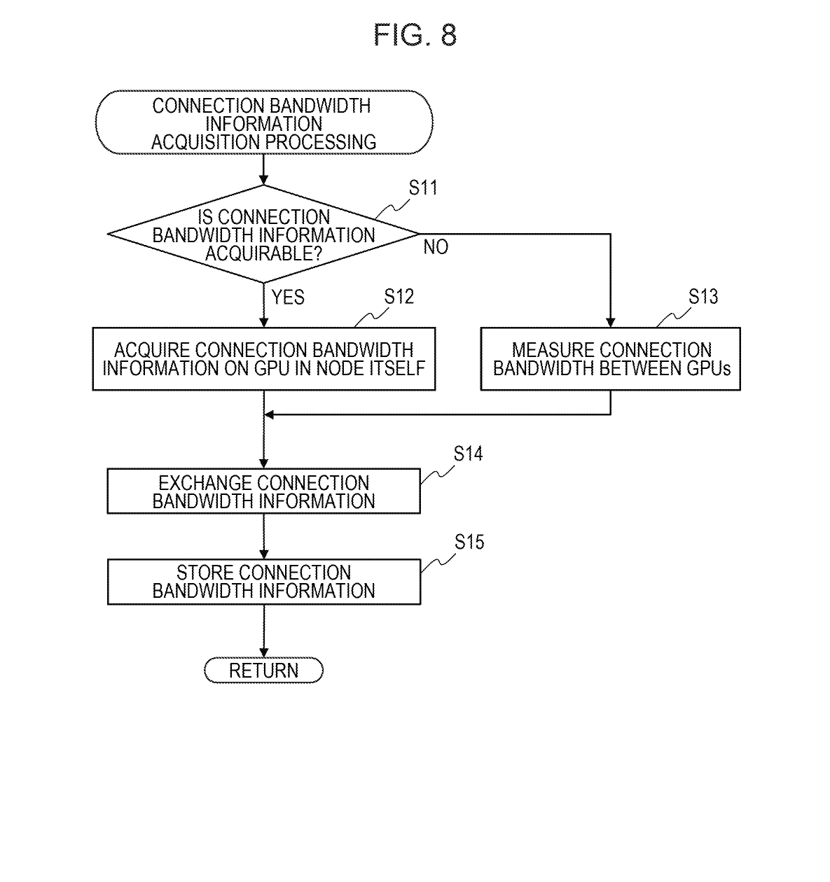

FIG. 8 is an example flowchart of acquisition processing for connection bandwidth information on the node 1. The processing illustrated in FIG. 8 is processing to be performed in each node 1, for instance. Also, the processing illustrated in FIG. 8 is processing to be performed in S2 of FIG. 7.

The CPU 11 of the node 1 determines whether or not the connection bandwidth information on each GPU 13 in the node 1 is acquirable (S11). For instance, the connection bandwidth information is acquirable from a driver of each GPU 13. When the connection bandwidth information on each GPU 13 in the node 1 is acquirable (YES in S11), the CPU 11 acquires the connection bandwidth information from each GPU 13 (S12).

When the connection bandwidth information is not acquirable (NO in S11), the CPU 11 measures a connection bandwidth between the GPUs 13 (S13). For instance, the CPU 11 only have to instruct to measure a predetermined volume of data transfer and transfer time. The GPU 13 only have to report a result of measurement of connection bandwidth to the CPU 11 which has instructed to measure a connection bandwidth.

Subsequently, the CPU 11 transfers the acquired connection bandwidth information to another node 1, for instance, by interprocess communication using an MPI, and also receives connection bandwidth information in another node 1 from another node 1 (exchange of connection bandwidth information) (S14). For instance, the CPU 11 outputs the acquired connection bandwidth information to a file, and stores the file in the memory 12 (S15). Subsequently, the processing illustrated in FIG. 8 is completed and the processing proceeds to S3 of FIG. 7. For example, as a connection bandwidth between the GPUs 13 serving for inter-node communication, the bandwidth of the high-speed inter-node network 20 may be adopted.

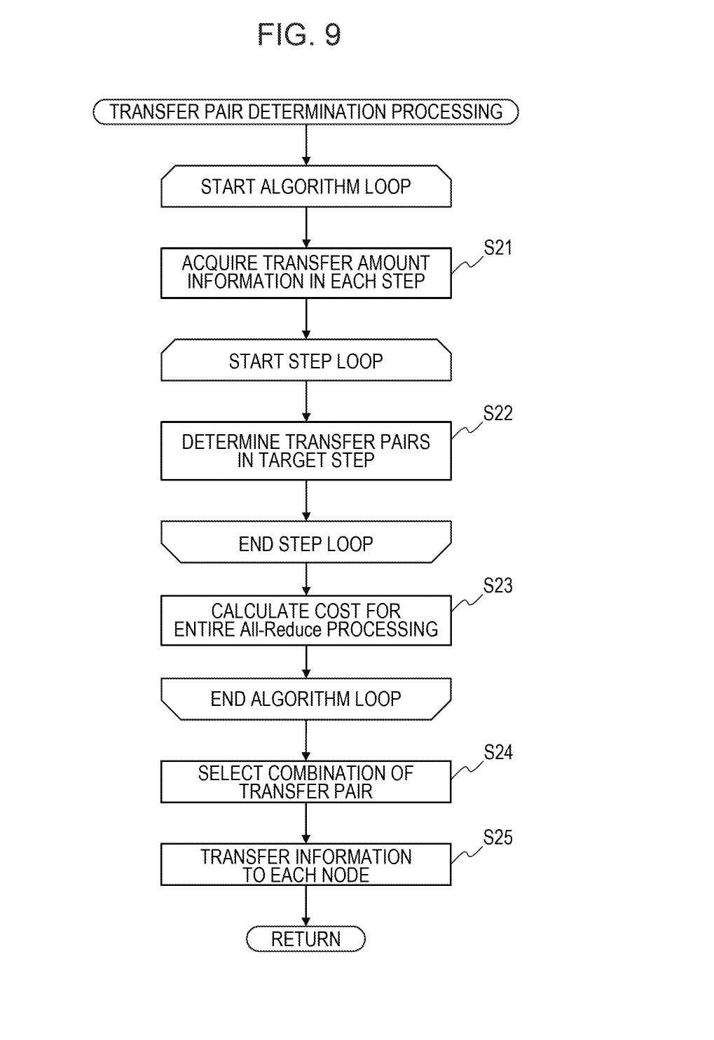

FIG. 9 is an example flowchart of transfer pair determination processing. In the first embodiment, the processing illustrated in FIG. 9 is performed by causing the CPU 11 of the node 1, which performs the transfer pair determination processing, to execute a transfer pair determination program. Also, the processing illustrated in FIG. 9 is performed in S3 of FIG. 7.

First, an algorithm loop is started. The algorithm loop includes the processing in S21 to S23. The algorithm loop is repeatedly executed the same number of times as the number of algorithms for the All-Reduce processing as a target.

In the algorithm loop, the CPU 11 first acquires the number of steps and transfer amount information Ti (i is a positive integer) in each step i (S21). The transfer amount information Ti is, for instance, the amount of data transfer per GPU in step i. The number of steps is an example of the “number of steps taken for the calculation result data of the plurality of arithmetic processors to be shared among the plurality of arithmetic processors”. The transfer amount information is an example of the “transfer data amount”.

For instance, when the number of GPUs (or N) is the nth power of 2, in the Butterfly method, the number of steps is log[2] N (or n) where [ ] indicates the base of the logarithm, and the transfer amount information Ti in step i is M. For instance, when the number of GPUs (or N) is other than the nth power of 2 (when the number of GPUs=the nth power of 2+X), in the Butterfly method, the number of steps is 2+log[2] N, and the transfer amount information Ti in step i is M. Here, N is the number of GPUs and M is the data size of each GPU.

For instance, in the Halving/Doubling method, when the number of GPUs is the Nth power of 2, the number of steps is 2×log[2] N. From step 1 to step S (S=log[2] N), the transfer amount information Ti in step i (of the aggregation processing) is M/2̂i. From step S+1 to step 2×S, the transfer amount information Ti in step i (of the sharing processing) is M/2̂(2×S−i+1).

For instance, in the Halving/Doubling method, when the number of GPUs (or N) is other than the nth power of 2 (when the number of GPUs=the nth power of 2+X), the number of steps is 2+2×log[2] N. The transfer amount information Ti in step 1 and the last step is M. From step 2 to step S (S=1+log[2] N), the transfer amount information Ti in step i (of the aggregation processing) is M/2̂i. From step S+1 to step 2×S−1, the transfer amount information Ti in step i (of the sharing processing) is M/2̂(2×S−i).

Subsequently, a step loop is started. The step loop includes the processing in S22. The step loop is repeatedly executed the same number of times as the number of algorithms for the All-Reduce processing as a target.

In the step loop, the CPU 11 determines transfer pairs in a target step (S22). The CPU 11 acquires selectable transfer pairs in all variations in step i. For instance, when the number of GPUs is four, in the Butterfly method, six combinations of transfer pairs are acquired through the entire All-Reduce processing. When the processing in S22 is completed, the step loop is completed.

When the step loop is completed, for each combination of transfer pairs, the CPU 11 calculates the time cost for the entire All-Reduce processing (S23). The time cost is calculated, for instance, as the total of transfer times over all the steps, where a transfer time for step i is Ti/min (Wm, n) which is a transfer time for a transfer pair in the slowest bandwidth (min(Wm,n)) among the transfer pairs in step i. For example, the time cost for each combination of transfer pairs is given by the following Expression 1. The time cost for each combination of transfer pairs is an example of the “first time”.

Time Cost=ΣTi/min(Wm,n) (Expression 1)

When the algorithm loop is completed, the CPU 11 selects combinations of transfer pairs (S24). For instance, the CPU 11 selects a combination of transfer pairs with the lowest time cost. Note that multiple combinations of transfer pairs may be selected. For instance, the CPU 11 may select a predetermined number of combinations of transfer pairs with the lowest time cost up to the predetermined number-th lowest time cost. Also, for instance, the CPU 11 may select combinations of transfer pairs with a time cost less than or equal to the lowest time cost+α, where α is, for instance, 5% of the lowest time cost.

Subsequently, the CPU 11 transfers All-Reduce information including the number of steps, the transfer amount information in each step, and the information on transfer pairs in each step to a memory 102 of another node 1. Subsequently, the processing illustrated in FIG. 9 is completed, and the processing proceeds to S4 of FIG. 7.

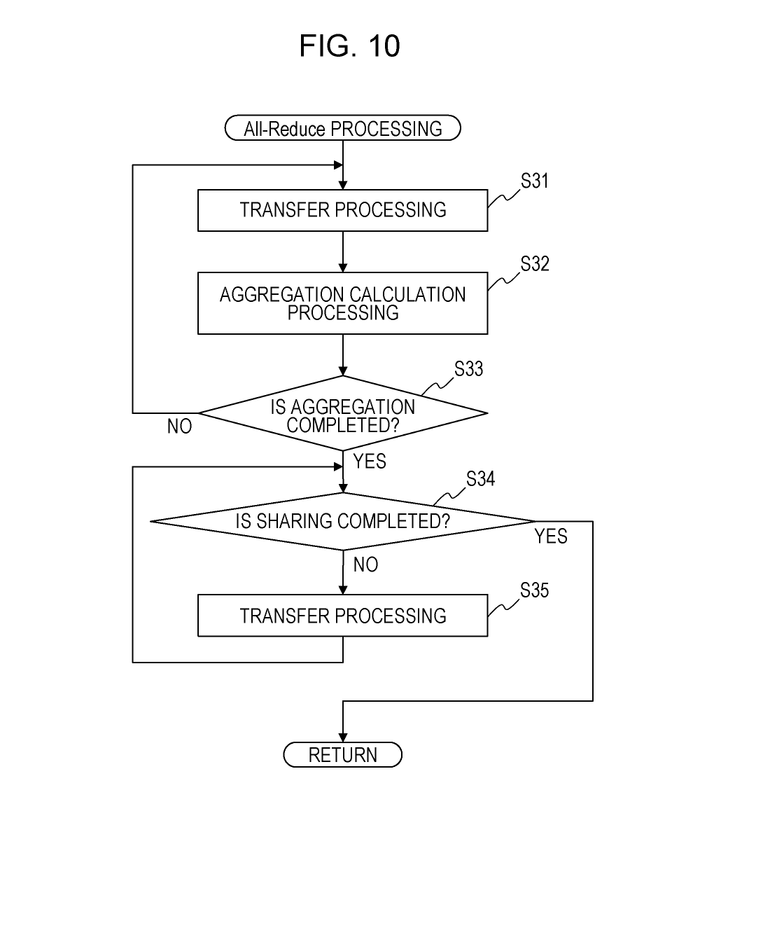

FIG. 10 is an example flowchart of the All-Reduce processing. The processing illustrated in FIG. 10 is performed in S6 of FIG. 7. The processing illustrated in FIG. 10 is performed in each node 1 in the deep learning system 100.

The processing in S31 and S32 corresponds to processing in one step of the algorithm for the All-Reduce processing. First, each GPU 13 transfers the gradient information (∇E) on each neuron layer to the memory 14 of the other GPU 13 in the transfer pair in accordance with All-Reduce information (S31). At this point, when the other GPU 13 in the transfer pair is present in the node 1, the GPU 13 transfers the gradient information (∇E) to the memory 14 of the other GPU 13 in the transfer pair, for instance, by using the NCCL.

On the other hand, when the other GPU 13 in the transfer pair is present in another node 1, the GPU 13 transfers the gradient information (∇E) to the memory 12 of the CPU 11. The CPU 11 transfers the gradient information (∇E) to the CPU 11 of another node 1 having the other GPU 13 in the transfer pair, for instance, by using an MPI. The CPU 11 of another node 1 having the other GPU 13 in the transfer pair transfers the gradient information to the other GPU 13 in the transfer pair.

Subsequently, each GPU 13 performs aggregation calculation processing, based on the transferred gradient information (∇E) and the gradient information stored (S32). The aggregation calculation processing is processing that calculates an average value of the gradient information (∇E) stored in the GPU 13 and the transferred gradient information (∇E), for instance. The data size of the gradient information (∇E) transmitted in S31 and S32 depends on the algorithm being executed for the All-Reduce processing.

Subsequently, the CPU 11 determines whether or not aggregation of the gradient information on all the GPUs 13 in the deep learning system 100 is completed (S33). Whether or not aggregation of the gradient information on all the GPUs 13 in the deep learning system 100 is completed is determined, for instance, based on the algorithm being executed for the All-Reduce processing and the current step number. For instance, in the case of the Butterfly method, when all the steps are completed, the CPU 11 determines that aggregation of the gradient information on all the GPUs 13 in the deep learning system 100 is completed. For instance, in the case of the Halving/Doubling method, when half of all the steps are completed, the CPU 11 determines that aggregation of the gradient information on all the GPUs 13 in the deep learning system 100 is completed.

When it is determined that aggregation of the gradient information on all the GPUs 13 in the deep learning system 100 is not completed (NO in S33), in the subsequent steps of the All-Reduce processing, the processing in S31 and S32 is performed.

When it is determined that aggregation of the gradient information on all the GPUs 13 in the deep learning system 100 is completed (YES in S33), the CPU 11 determines whether or not sharing of the aggregated gradient information is completed (S34). Whether or not sharing of the aggregated gradient information is completed is determined, for instance, based on the algorithm being executed for the All-Reduce processing and the current step number.

For instance, in the case of the Butterfly method or the Halving/Doubling method, when all the steps are completed, the CPU 11 determines that sharing of the gradient information by all the GPUs 13 in the deep learning system 100 is completed.

When it is determined that sharing of the aggregated gradient information is not completed (NO in S34), each GPU 13 transfers the aggregated gradient information to the other GPU 13 in the transfer pair in the current step (S35). The processing in S35 is the same as the processing in S31. Note that when the currently executed algorithm for the All-Reduce processing is the Butterfly method, the transfer processing related to the sharing in S35 is not performed.

When it is determined that sharing of the aggregated gradient information is completed (YES in S34), the processing illustrated in FIG. 10 is completed, and the processing proceeds to S7 of FIG. 7.

### Example 1

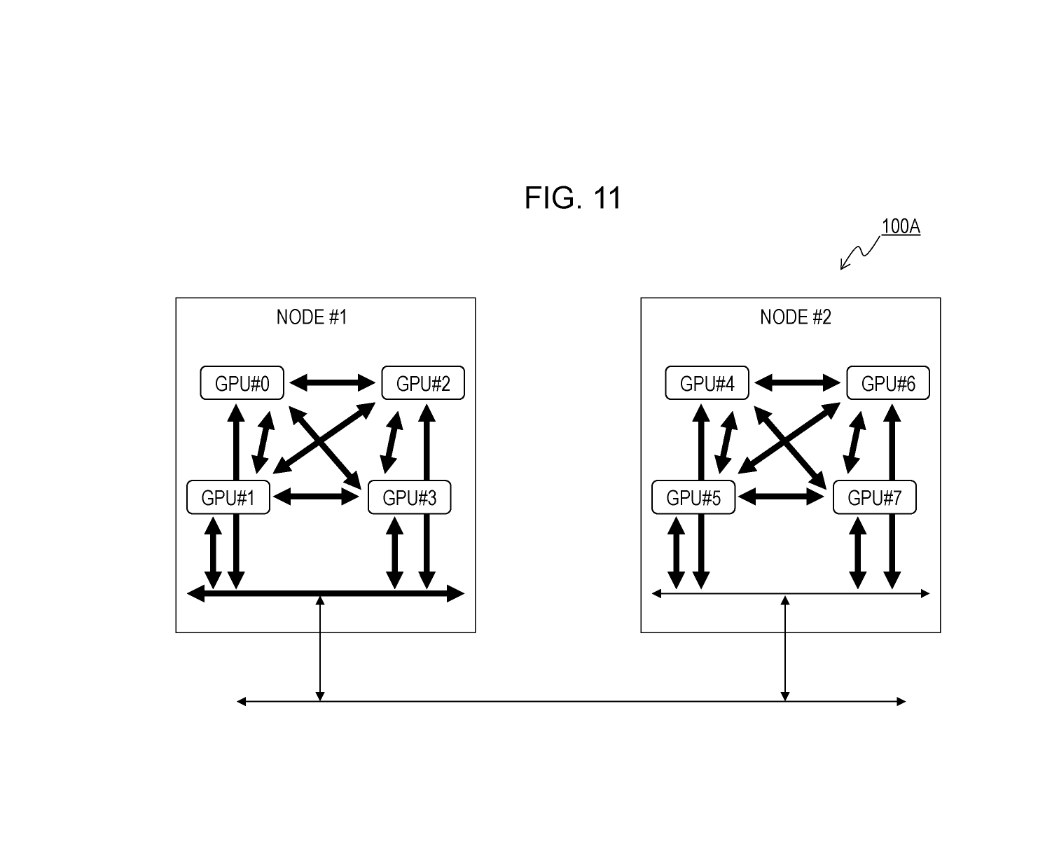

FIG. 11 is a diagram illustrating a system configuration of a deep learning system 100A according to Example 1. FIG. 11 is a diagram for illustrating a connection relationship between the GPUs 13 in the deep learning system 100A, and the components other than the GPUs 13 are omitted for the sake of simplicity. The same goes with Example 2 and Example 3 below.

The deep learning system 100A according to Example 1 includes two nodes: node #1 and node #2. The node #1 includes four GPUs 13: GPUs #0 to #3. The node #2 includes four GPUs 13: GPUs #4 to #7.

In Example 1, it is assumed that there is no hierarchical structure among the GPUs 13 in each of the node #1 and the node #2, and the same communication bandwidth is used in-node communication. However, it is assumed that the communication bandwidth of inter-node communication between the GPUs 13 in the node #1 and the GPUs 13 in the node #2 is smaller than the bandwidth of in-node communication.

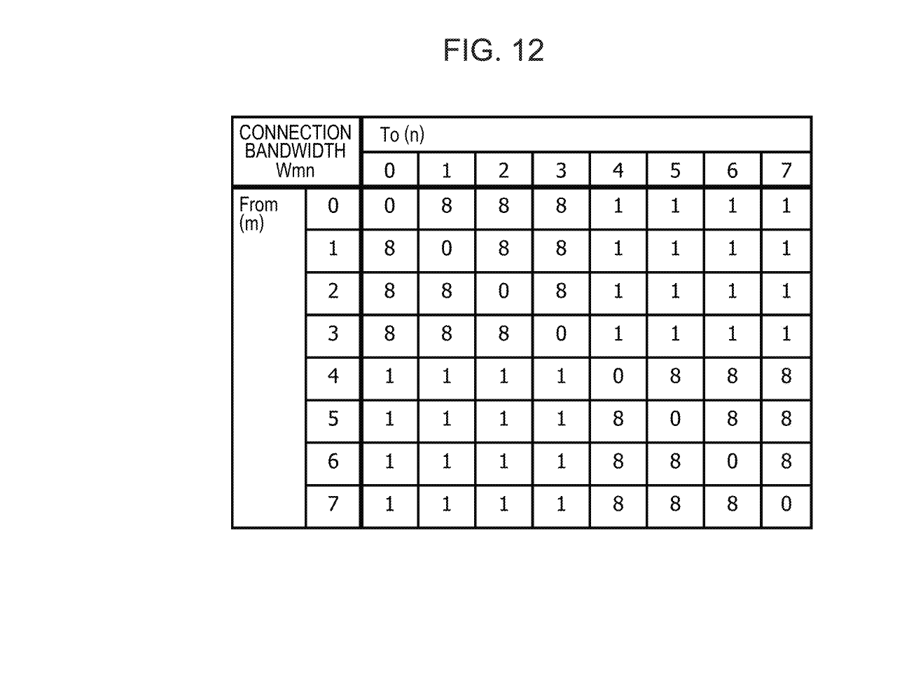

FIG. 12 is a diagram illustrating example connection bandwidth information in Example 1. The table of FIG. 12 lists identification information of the GPUs 13 with transfer sources (From: m) vertically arranged and transfer destinations (To: n) horizontally arranged. The example illustrated in FIG. 12 indicates that a transfer pair with a larger numerical value at the intersection thereof has a greater communication bandwidth. In the example illustrated in FIG. 12, connection bandwidth information of the GPUs 13 within the same node 1 is labeled with 8, and connection bandwidth information of the GPUs 13 between the different nodes 1 is labeled with 1. Note that the numerical values of connection bandwidth information illustrated in FIG. 12 are numerical values used as an example to indicate the difference of the speeds of communication bandwidths between the GPUs, and the connection bandwidth information is not limited to these values.

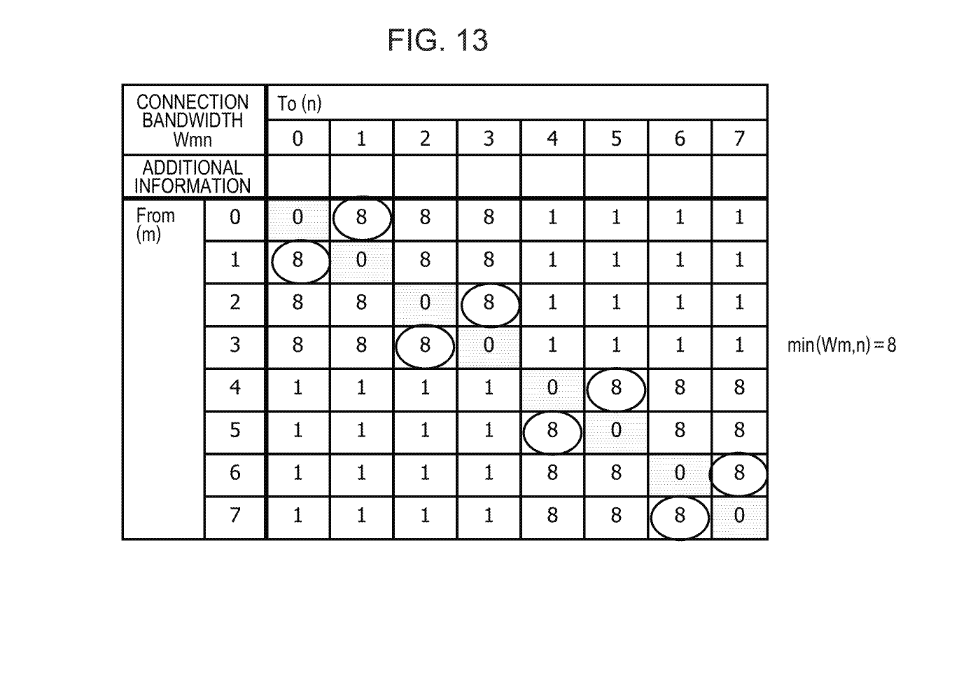

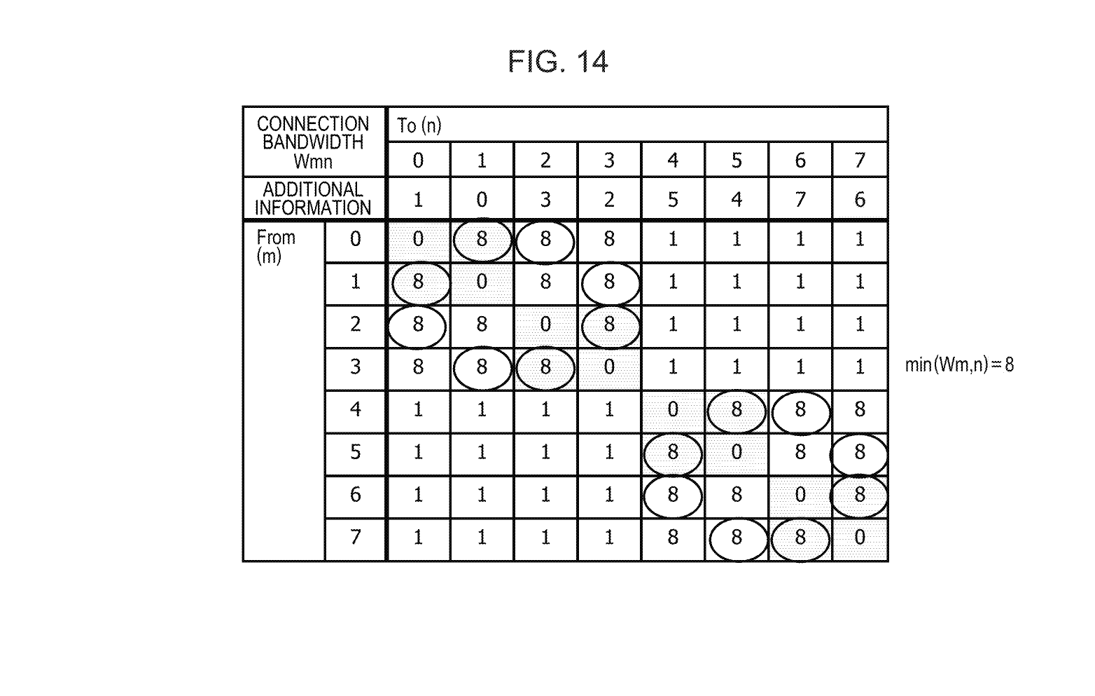

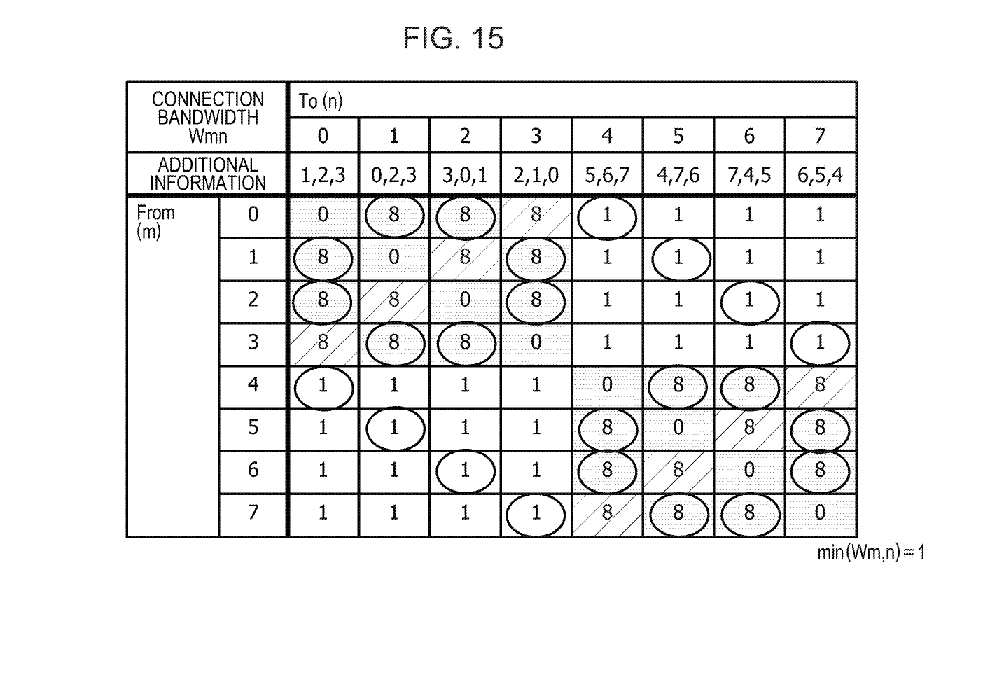

FIG. 13 is a diagram illustrating an example combination of transfer pairs in step 1 of the All-Reduce processing in Example 1. FIG. 13 illustrates one of combinations of transfer pairs whose minimum communication bandwidth min (Wm, n) among the transfer pairs is maximum among the selectable combinations of transfer pairs in step 1 of the All-Reduce processing. FIG. 13 illustrates the combination of transfer pairs, whose minimum communication bandwidth min (Wm, n) among the transfer pairs is maximum, by surrounding connection bandwidth information in white boxes with a circle. The hatched boxes in FIG. 13 indicate the combination of transfer pairs which is not selectable. The same goes with FIGS. 14 and 15 below.

For example, FIG. 13 illustrates GPU #0 and GPU #1, GPU #2 and GPU #3, GPU #4 and GPU #5, and GPU #6 and GPU #7 as the combination of transfer pairs whose minimum communication bandwidth min (Wm, n) among the transfer pairs is maximum. Since the communication bandwidth between any transfer pair is 8, the minimum communication bandwidth min (Wm, n) among the transfer pairs in step 1 illustrated in FIG. 13 is 8.

FIG. 14 is a diagram illustrating an example combination of transfer pairs in step 2 of the All-Reduce processing in Example 1. FIG. 14 illustrates one of combinations of transfer pairs whose minimum communication bandwidth min (Wm, n) among the transfer pairs is maximum among the selectable combinations of transfer pairs in step 2, in the case where a combination of transfer pairs in step 1 of the All-Reduce processing is the combination of transfer pairs illustrated in FIG. 13.

First, the identification number of the other in each transfer pair in step 1 is added to the additional information of each GPU in “To”. Since the data of the GPUs with the identification numbers listed in the additional information is already held, none of the GPUs with the identification numbers listed in the additional information is paired at the stage of aggregation processing, thus the boxes, in which GPU in “From” is listed in the additional information of GPU in “To”, are hatched.

A combination of transfer pairs in step 2 is selected from white boxes. FIG. 14 illustrates GPU #0 and GPU #2, GPU #1 and GPU #3, GPU #4 and GPU #6, and GPU #5 and GPU #7 as the combination of transfer pairs whose minimum communication bandwidth min (Wm, n) among the transfer pairs is maximum. Since the communication bandwidth between any transfer pair is 8, the minimum communication bandwidth min (Wm, n) among the transfer pairs in step 2 illustrated in FIG. 14 is 8.

FIG. 15 is a diagram illustrating an example combination of transfer pairs in step 3 of the All-Reduce processing in Example 1. FIG. 15 illustrates one of combinations of transfer pairs whose minimum communication bandwidth min (Wm, n) among the transfer pairs is maximum among the selectable combinations of transfer pairs in step 3, in the case where the combinations of transfer pairs in step 1 and step 2 of the All-Reduce processing are the combinations of transfer pairs illustrated in FIGS. 13 and 14, respectively.

First, the identification number of the other in each transfer pair in previous step 2 is added to the additional information of each GPU in “To”. The boxes, in which GPU in “From” is listed in the additional information of each GPU in “To”, are newly hatched.

In FIG. 15, the boxes for the combinations of GPUs #0 to #3 in “From” and GPUs #0 to 3 in “To”, and the combinations of GPUs #4 to #7 in “From” and GPUs #4 to 7 in “To” are hatched, in other words, not selectable.

The combination of transfer pairs in step 3 is selected from white boxes. FIG. 15 illustrates GPU #0 and GPU #4, GPU #1 and GPU #5, GPU #2 and GPU #6, and GPU #3 and GPU #7 as the combination of transfer pairs whose minimum communication bandwidth min (Wm, n) among the transfer pairs is maximum. Since the communication bandwidth between any transfer pair is 1, the minimum communication bandwidth min (Wm, n) among the transfer pairs in step 3 illustrated in FIG. 15 is 1.

When the Butterfly method is used and the number of GPUs is 8, all the steps of the All-Reduce processing are completed in step 3. When the Halving/Doubling method is used and the number of GPUs is 8, the aggregation processing is completed in step 3, and sharing processing is performed in step 4 and after. In the sharing processing using the Halving/Doubling method, the sharing processing may be performed, for instance, in step 4 between the same transfer pairs as in step 3, in step 5 between the same transfer pairs as in step 2, and in step 6 between the same transfer pairs as in step 1. In Example 1, the combination of transfer pairs in each step of the sharing processing using the Halving/Doubling method is as described above.

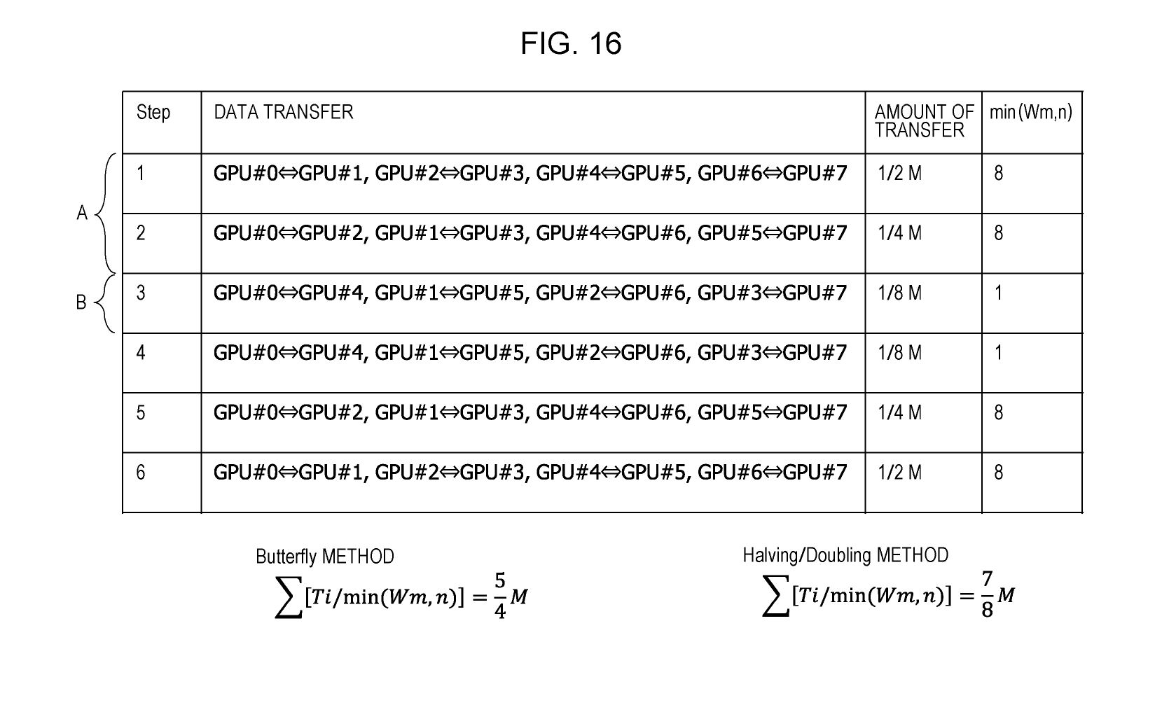

FIG. 16 is a diagram illustrating an example combination of transfer pairs in the Halving/Doubling method in Example 1. In the example illustrated in FIG. 16, the combination of transfer pairs in each of steps 1 to 3 (aggregation processing) is a combination of transfer pairs in which a minimum communication bandwidth min (Wm, n) among the transfer pairs is maximum in each step illustrated in FIGS. 13 to 15. In the example illustrated in FIG. 16, similarly to steps 3 to 1, the combination of transfer pairs in each of steps 4 to 6 (aggregation processing) is a combination in which a minimum communication bandwidth min (Wm, n) among the transfer pairs is maximum in each step illustrated in FIGS. 13 to 15.

FIG. 16 illustrates the transfer amount information Ti and the minimum communication bandwidth min (Wm, n) in each step.

In the first embodiment, the time cost in each step of the All-Reduce processing is given by a maximum transfer time in all the transfer pairs. In other words, the time cost in each step is given by the transfer amount information Ti/the minimum communication bandwidth min (Wm, n) in each step i. Therefore, the time cost for all the steps of the algorithm is given by the total of the time costs for all the steps (see Expression 1).

In the case of the combination of transfer pairs using the Halving/Doubling method illustrated in FIG. 16, the time cost is 7/8×M. In the case of the Butterfly method, the transfer amount information Ti in each step is M, and thus the time cost for the combinations of transfer pairs in steps 1 to 3 illustrated in FIG. 16 is 5/4×M.

Thus, for the case of the combinations of transfer pairs illustrated in FIG. 16, the Halving/Doubling method with less time cost is selected.

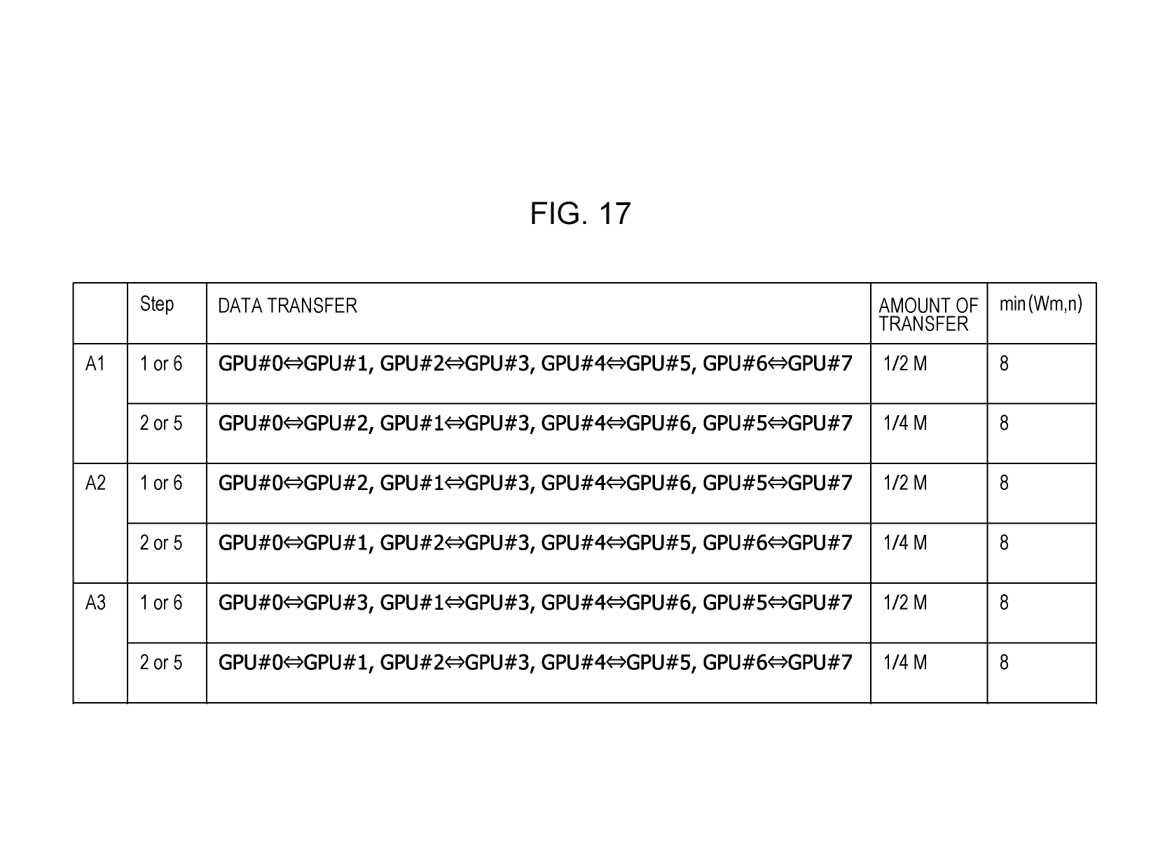

FIG. 17 is a diagram illustrating an example variation in combinations of transfer pairs in step 1 and step 2 illustrated in FIG. 16. The combinations of transfer pairs in step 1 and step 2 of A1 illustrated in FIG. 17 are the same combinations of transfer pairs as in step 1 and step 2, respectively illustrated in FIG. 16.

The combinations of transfer pairs in step 1 and step 2 of A2, A3 illustrated in FIG. 17 have the same values of the transfer amount information Ti and the minimum communication bandwidth min (Wm, n) among the transfer pairs as the combinations of transfer pairs in step 1 and step 2 of A1. In other words, in FIG. 16, each of the combinations of transfer pairs in step 1 and step 2 may be one of the combinations of transfer pairs in step 1 and step 2 of A2 or A3 illustrated in FIG. 17. Also, when multiple combinations are selected, the combinations of transfer pairs in step 1 and step 2 may be selected from the combinations of transfer pairs in step 1 and step 2 of A2 or A3 illustrated in FIG. 17.

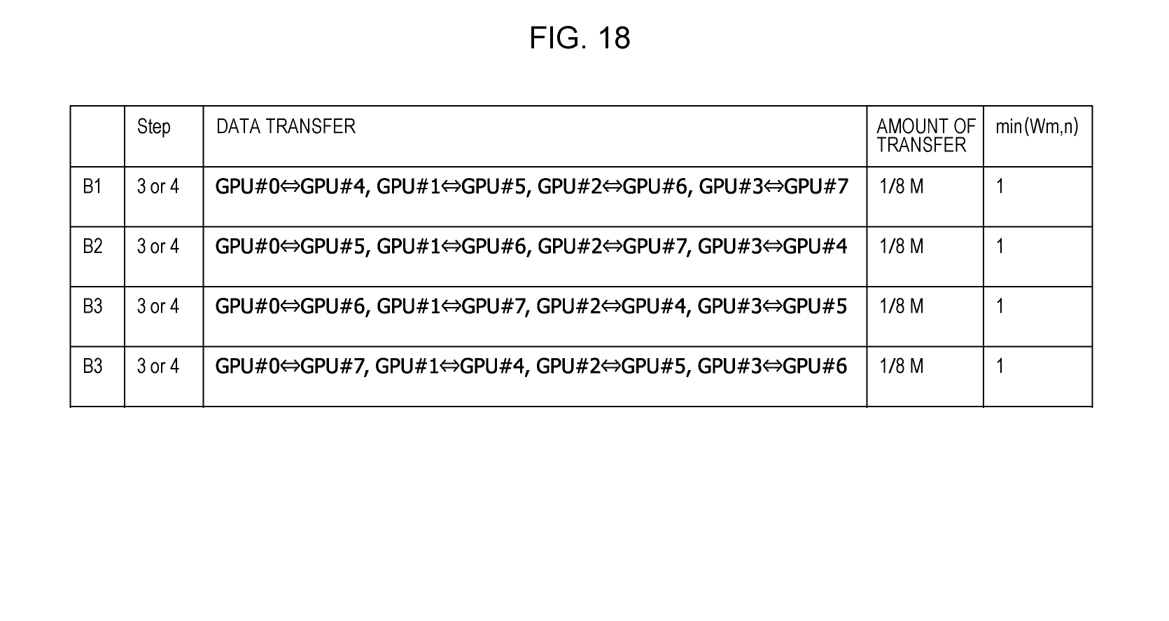

FIG. 18 is a diagram illustrating an example variation in combination of transfer pairs in step 3 illustrated in FIG. 16. The combination of transfer pair of B1 illustrated in FIG. 18 is the same as the combination of transfer pair in step 3 illustrated in FIG. 16.

The combinations of transfer pairs in B2 to B4 illustrated in FIG. 18 have the same values of the transfer amount information Ti and the minimum communication bandwidth min (Wm, n) among the transfer pairs as the combination of transfer pairs in B1. In other words, in FIG. 16, the combination of transfer pairs in step 3 may be the combination of transfer pairs in one of B2 to B4 illustrated in FIG. 18. Also, when multiple combinations of transfer pairs are selected, the combination of transfer pairs in step 3 may be selected from the combinations of transfer pairs in B2 to B4 illustrated in FIG. 18.

Note that in the case of the Halving/Doubling method, the combination of transfer pairs in step 4 of FIG. 16 may be the combination of transfer pairs in one of B2 to B4 illustrated in FIG. 18. Also, in the case of the Halving/Doubling method, each of the combinations of transfer pairs in step 5 and step 6 of FIG. 16 may be one of the combinations of transfer pairs in step 2 and step 1 of one of A1 and A2 illustrated in FIG. 17.

### Example 2

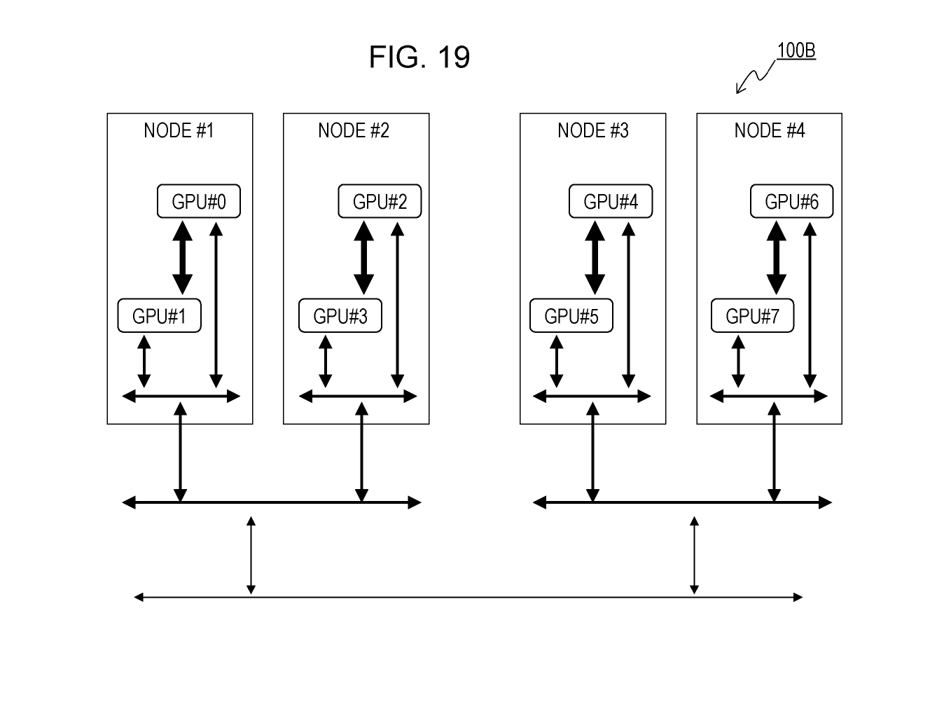

FIG. 19 is a diagram illustrating a system configuration of a deep learning system 100B according to Example 2. The deep learning system 100B according to Example 2 includes four nodes: node #1, node #2, node #3, and node #4. The node #1 includes two GPUs 13: GPU #0 and GPU #1. The node #2 includes two GPUs 13: GPU #3 and GPU #4. The node #3 includes two GPUs 13: GPU #4 and GPU #5. The node #4 includes two GPUs 13: GPU #6 and GPU #7.

In Example 2, it is assumed that there is no hierarchical structure between two GPUs in each of the node #1 to node #4. However, in the deep learning system 100B in Example 2, a hierarchical structure is present for communication among different nodes. The node #1 and the node #2, and the node #3 and the node #4 form pairs, and it is assumed that communication between paired nodes provides higher speed than communication between unpaired nodes. In other words, in the deep learning system 100B in Example 2, the descending order of speed of communication between GPUs is as follows: in-node communication>communication between paired nodes>communication between unpaired nodes.

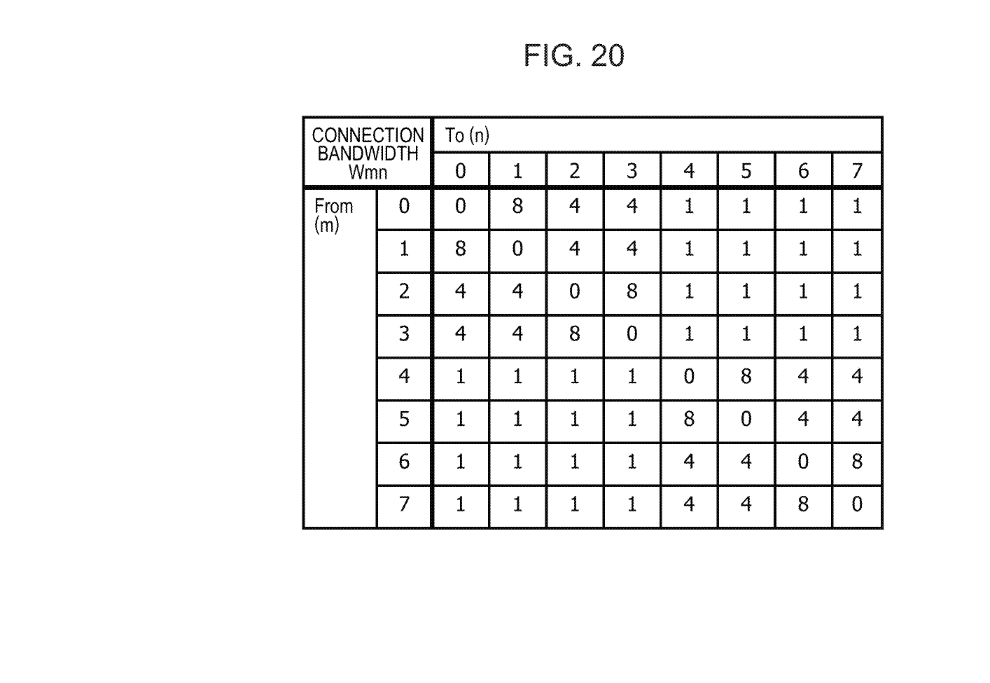

FIG. 20 is a diagram illustrating an example of connection bandwidth information in Example 2. The example illustrated in FIG. 20 indicates that the connection bandwidth information between the GPUs in the same node 1 is 8, the connection bandwidth information between the GPUs in paired nodes is 4, and the connection bandwidth information between the GPUs in unpaired nodes is 1.

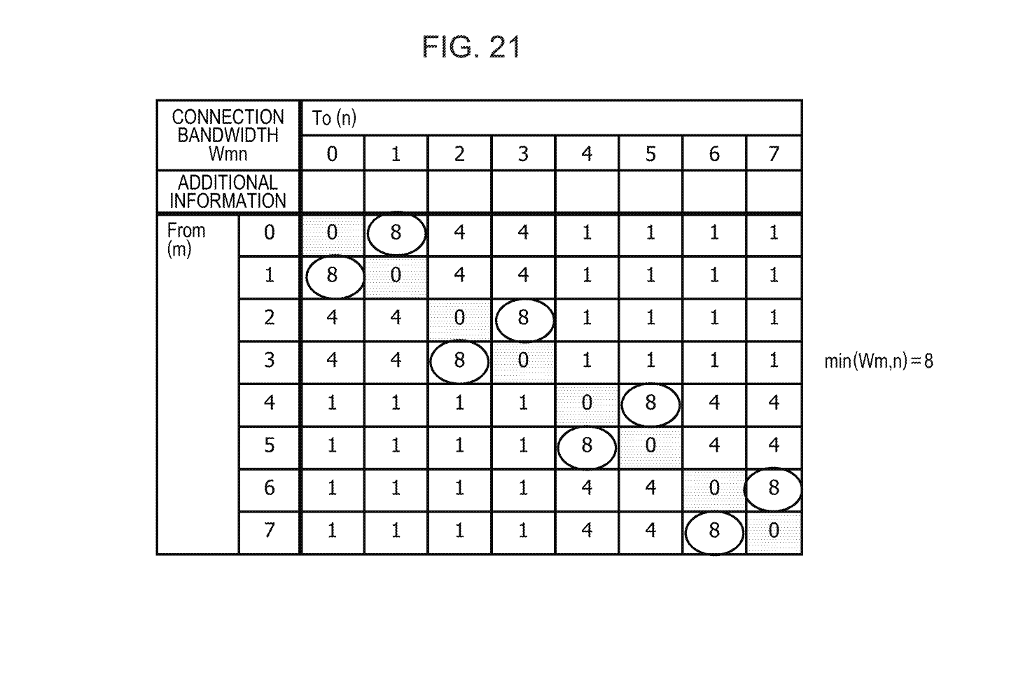

FIG. 21 is a diagram illustrating an example of a combination of transfer pairs in step 1 of the All-Reduce processing in Example 2. FIG. 21 illustrates one of the combinations of transfer pairs in which a minimum communication bandwidth min (Wm, n) among the transfer pairs is maximum among the selectable combinations of transfer pairs in step 1 of the All-Reduce processing.

For example, FIG. 21 illustrates GPU #0 and GPU #1, GPU #2 and GPU #3, GPU #4 and GPU #5, and GPU #6 and GPU #7 as the combination of transfer pairs whose minimum communication bandwidth min (Wm, n) among the transfer pairs is maximum. Since the communication bandwidth between any transfer pair is 8, the minimum communication bandwidth min (Wm, n) among the transfer pairs in step 1 illustrated in FIG. 21 is 8.

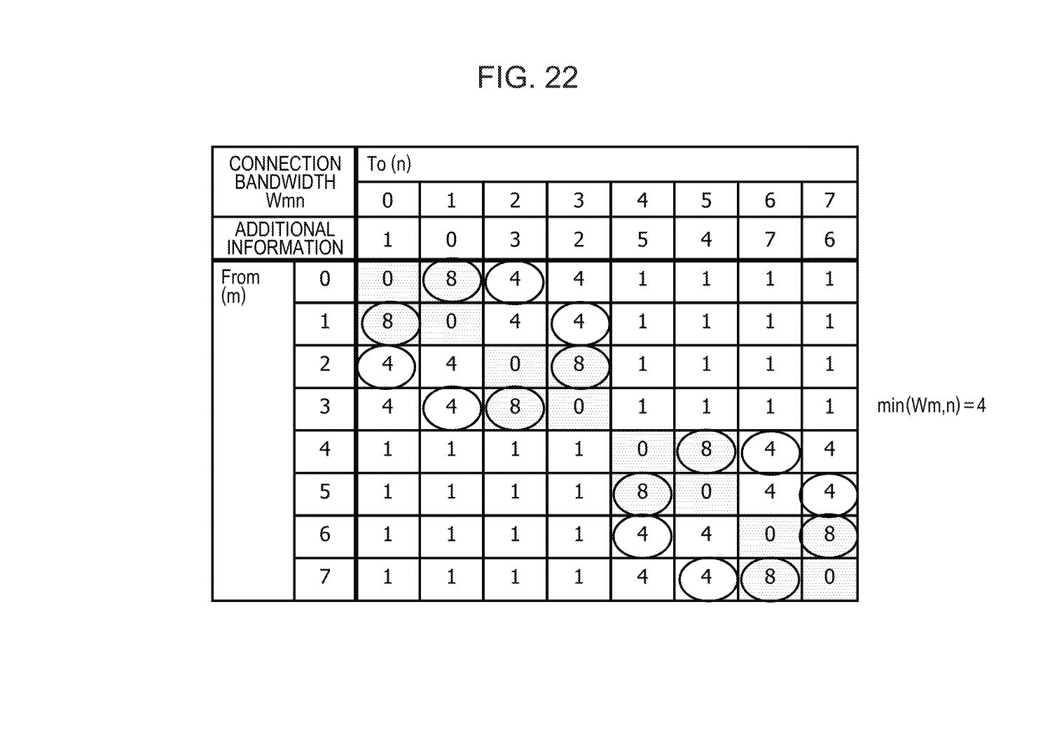

FIG. 22 is a diagram illustrating an example of a combination of transfer pairs in step 2 of the All-Reduce processing in Example 2. FIG. 22 illustrates one of the combinations of transfer pairs whose minimum communication bandwidth min (Wm, n) among the transfer pairs is maximum among the selectable combinations of transfer pairs in step 2, in the case where the combination of transfer pairs in step 1 of the All-Reduce processing is the combination of transfer pairs illustrated in FIG. 21.

FIG. 22 illustrates GPU #0 and GPU #2, GPU #1 and GPU #3, GPU #4 and GPU #6, and GPU #5 and GPU #7 as the combination of transfer pairs whose minimum communication bandwidth min (Wm, n) among the transfer pairs is maximum. Since the communication bandwidth between any transfer pair is 4, the minimum communication bandwidth min (Wm, n) among the transfer pairs in step 2 illustrated in FIG. 22 is 4.

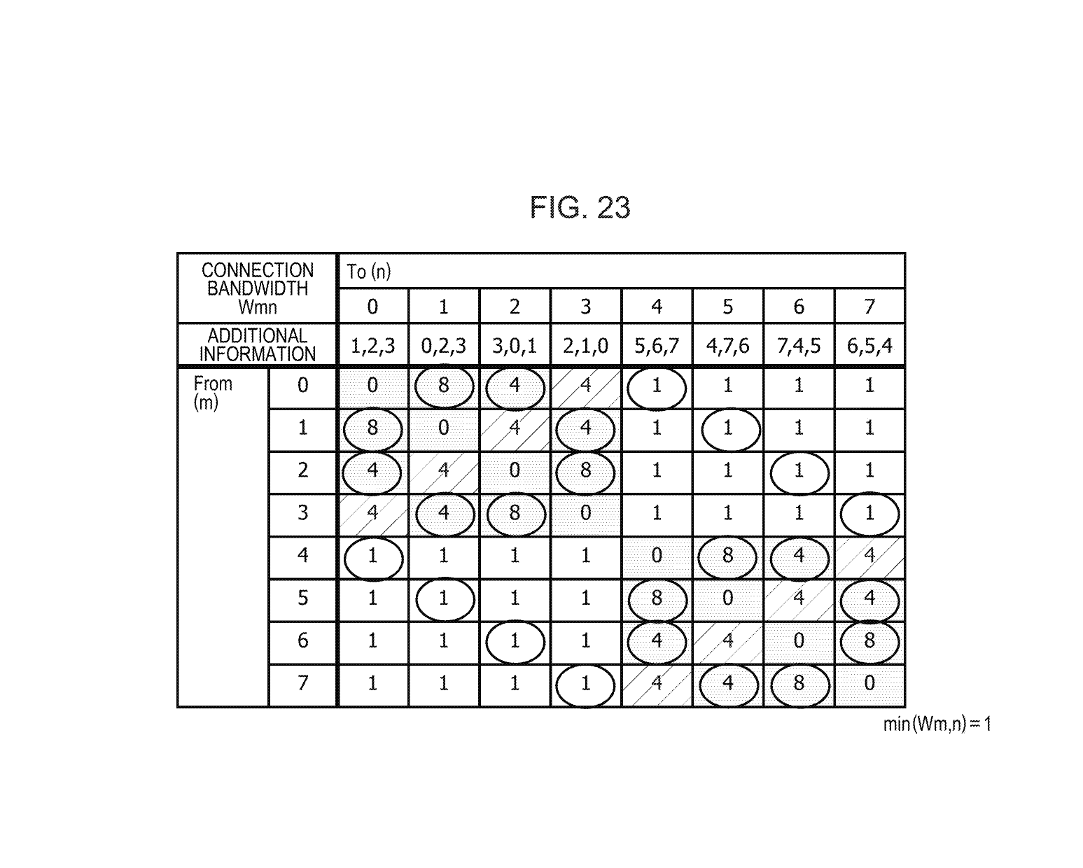

FIG. 23 is a diagram illustrating an example of a combination of transfer pairs in step 3 of the All-Reduce processing in Example 2. FIG. 23 illustrates one of the combinations of transfer pairs whose minimum communication bandwidth min (Wm, n) among the transfer pairs is maximum among the selectable combinations of transfer pairs in step 3, in the case where the combinations of transfer pairs in step 1 and step 2 of the All-Reduce processing are the combinations of transfer pairs illustrated in FIGS. 21 and 22, respectively.

First, the identification number of the other in each transfer pair in previous step 2 is added to the additional information of each GPU in “To”. The boxes, in which GPU in “From” is listed in the additional information of each GPU in “To”, are newly hatched.

FIG. 23 illustrates GPU #0 and GPU #4, GPU #1 and GPU #5, GPU #2 and GPU #6, and GPU #3 and GPU #7 as the combination of transfer pairs in which a minimum communication bandwidth min (Wm, n) among the transfer pairs is maximum. Since the communication bandwidth between any transfer pair is 1, the minimum communication bandwidth min (Wm, n) among the transfer pairs in step 3 illustrated in FIG. 23 is 1.

Similarly to Example 1, in Example 2, the number of GPUs is 8, thus in the case of the Butterfly method, all the steps of the All-Reduce processing are completed in step 3. In the case of the Halving/Doubling method, since the number of GPUs is 8, the processing continues to step 6. Also, in Example 2, the combination of transfer pairs in each step of the sharing processing using the Halving/Doubling method is the same as a combination of transfer pairs in each step in the reverse order of the aggregation processing.

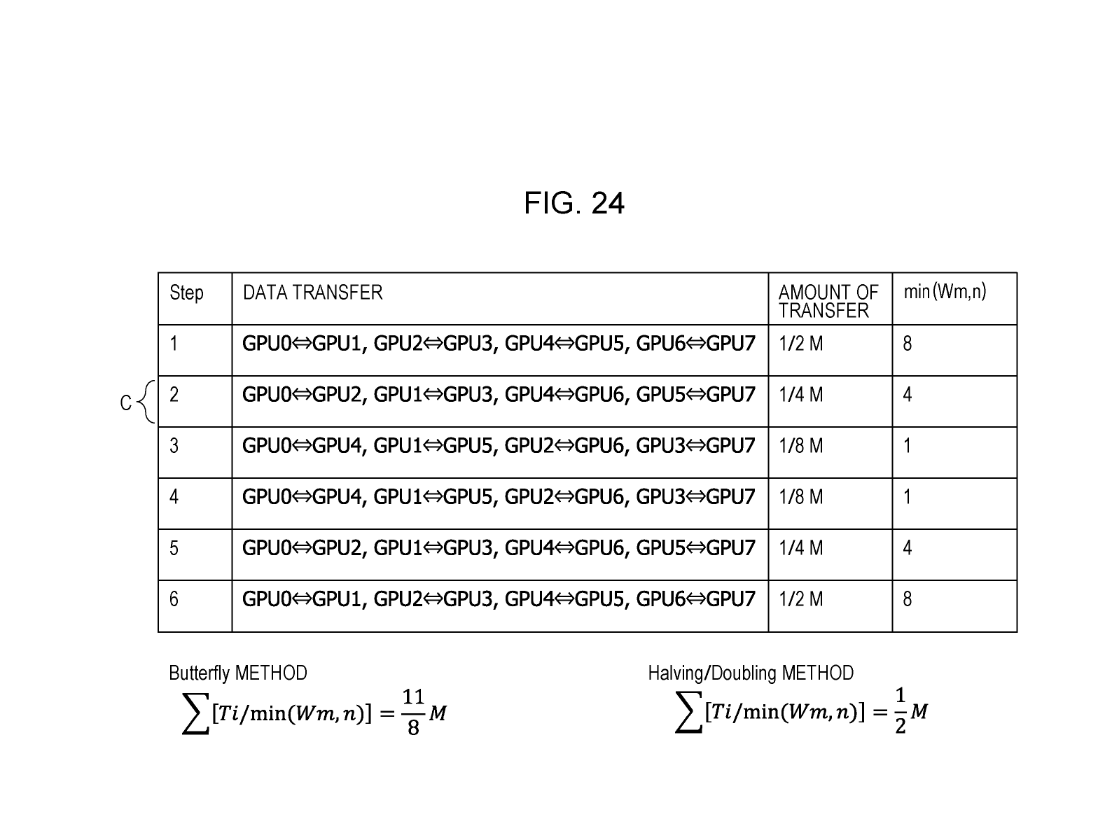

FIG. 24 is a diagram illustrating an example of combinations of transfer pairs in the Halving/Doubling method in Example 2. In the example illustrated in FIG. 24, the combination of transfer pairs in each of steps 1 to 3 (aggregation processing) is a combination of transfer pairs whose minimum communication bandwidth min (Wm, n) among the transfer pairs is maximum in each step illustrated in FIGS. 21 to 23. In the example illustrated in FIG. 24, similarly to steps 3 to 1, the combination of transfer pairs in each of steps 4 to 6 (aggregation processing) is a combination of transfer pairs whose minimum communication bandwidth min (Wm, n) among the transfer pairs is maximum in each step illustrated in FIG. 21 to FIG. 23.

In the case of the combinations of transfer pairs using the Halving/Doubling method illustrated in FIG. 24, the time cost is 1/2×M. In the case of the Butterfly method, the combinations of transfer pairs in steps 1 to 3 illustrated in FIG. 24 are obtained, the transfer amount information Ti in each step is M, and thus the time cost is 11/8×M.

Thus, for the case of the combinations of transfer pairs illustrated in FIG. 24, the Halving/Doubling method with less time cost is selected.

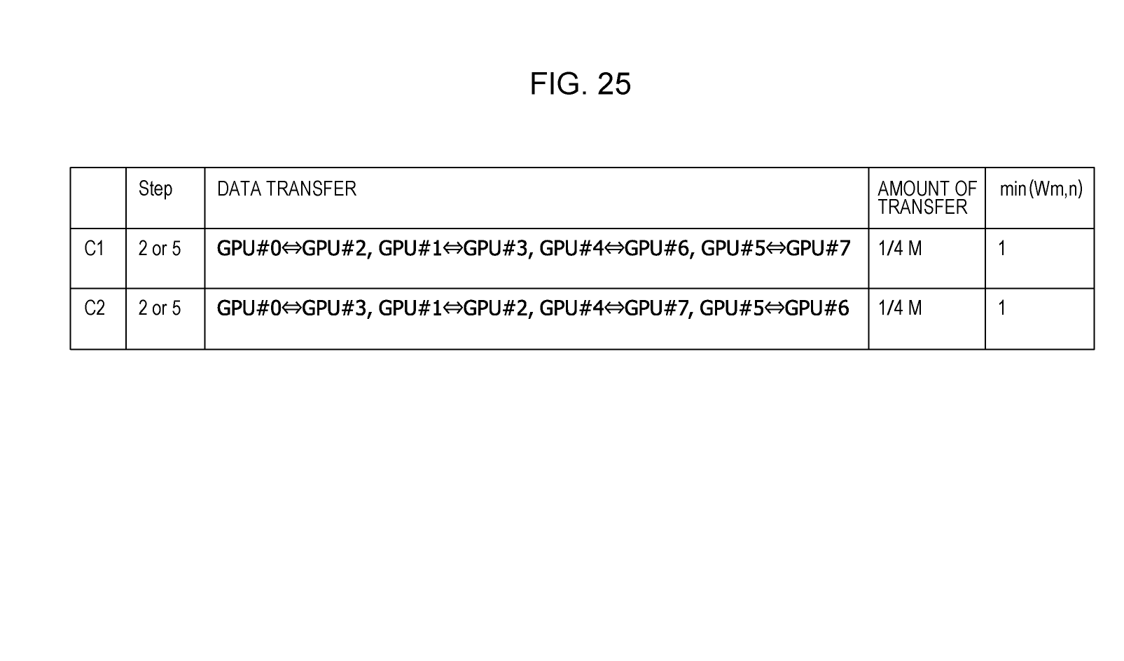

FIG. 25 is a diagram illustrating an example of variation in the combination of transfer pairs in step 2 illustrated in FIG. 24. The combination of transfer pairs in step 2 of C1 illustrated in FIG. 25 is the same as the combination of transfer pairs in step 2 illustrated in FIG. 24.

The combination of transfer pairs of C2 illustrated in FIG. 25 has the same values of the transfer amount information Ti and the minimum communication bandwidth min (Wm, n) among the transfer pairs as the combination of transfer pairs of C1. In other words, in FIG. 24, the combination of transfer pairs in step 2 may be the combination of transfer pairs in C2 illustrated in FIG. 25. Also, when multiple combinations are selected, the combination of transfer pairs in C2 illustrated in FIG. 25 may also selected as one of the selectable combinations of transfer pairs in step 2.

The variation in the combination of transfer pairs in step 3 of FIG. 24 is the same as the combination of transfer pairs illustrated in FIG. 18 of Example 1.

In the case of the Halving/Doubling method, the combination of transfer pairs in step 5 of FIG. 24 may be the combination of transfer pairs in C2 of FIG. 25. Also, in the case of the Halving/Doubling method, each of the combinations of transfer pairs in step 3 and step 4 of FIG. 24 may be the combination of transfer pairs in one of B2 to B4 of FIG. 18.

### Example 3

The system configuration of a deep learning system according to Example 3 is the same as the system configuration of Example 1. In Example 3, a case is assumed where abnormality occurs in connection from GPU #3 to GPU #2, and the communication bandwidth from GPU #3 to GPU #2 is reduced. When the GPUs are connected via a bidirectional bus, connection from GPU #3 to GPU #2, and connection from GPU #2 to GPU #3 have the same value of communication bandwidth. However, in a unidirectional bus, a failure may occur in one way.

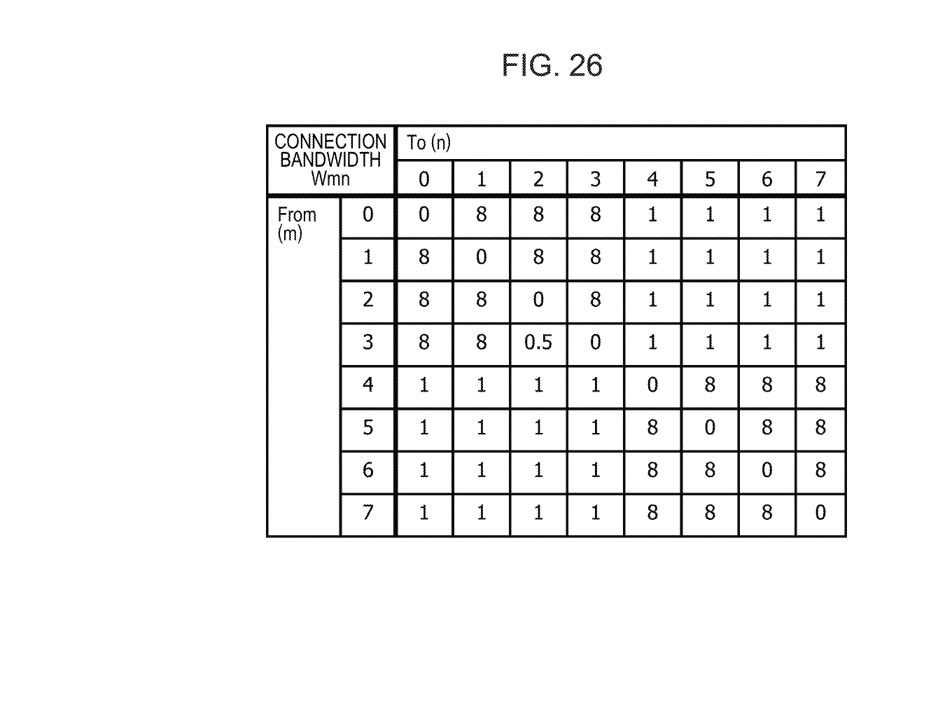

FIG. 26 is a diagram illustrating an example of connection bandwidth information in Example 3. The example illustrated in FIG. 26 indicates that the connection bandwidth information between the GPUs in the same node 1 is 8, the connection bandwidth information between the GPUs in different nodes is 8. In Example 3, since it might be expected that the communication bandwidth from GPU #3 to GPU #2 is reduced, the connection bandwidth information from GPU #3 to GPU #2 is a low value, 0.5.

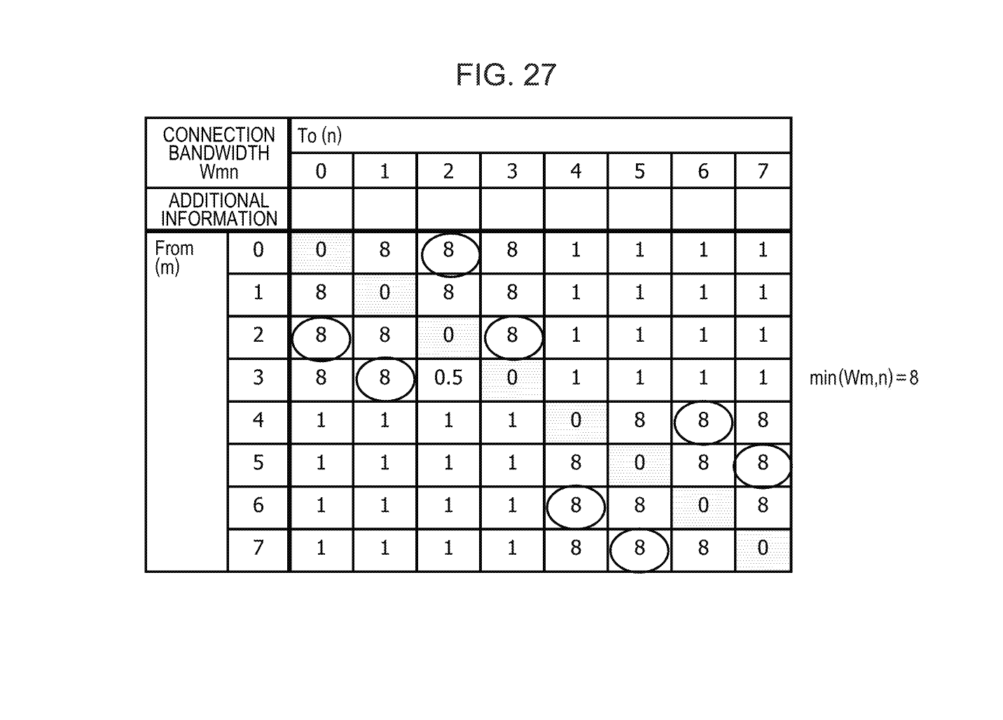

FIG. 27 is a diagram illustrating an example of a combination of transfer pairs in step 1 of the All-Reduce processing in Example 3. FIG. 27 illustrates one of the combinations of transfer pairs whose minimum communication bandwidth min (Wm, n) among the transfer pairs is maximum among the selectable combinations of transfer pairs in step 1 of the All-Reduce processing.

For example, FIG. 27 illustrates GPU #0 and GPU #2, GPU #1 and GPU #3, GPU #4 and GPU #6, and GPU #5 and GPU #7 as the combination of transfer pairs whose minimum communication bandwidth min (Wm, n) among the transfer pairs is maximum. Since the communication bandwidth between any transfer pair is 8, the minimum communication bandwidth min (Wm, n) between the transfer pairs in step 1 illustrated in FIG. 27 is 8.

Unlike Example 1, in Example 3, the connection bandwidth information from GPU #3 to GPU #2 is 0.5, thus a combination including the pair of GPU #3 and GPU #2 is excluded from the combinations in which a minimum communication bandwidth min (Wm, n) among the transfer pairs is maximum.

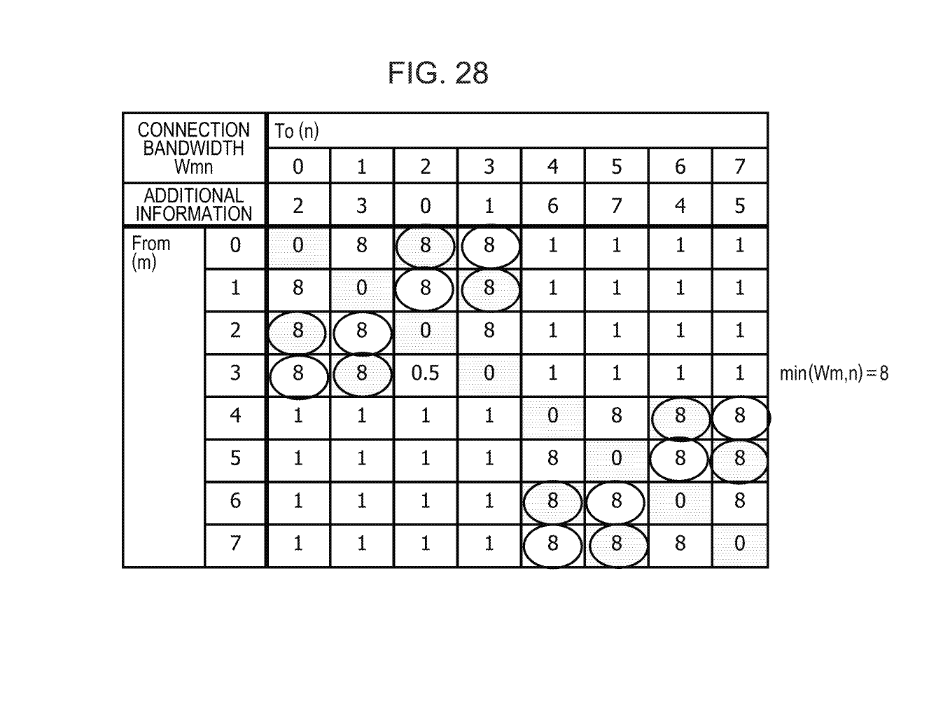

FIG. 28 is a diagram illustrating an example of a combination of transfer pairs in step 2 of the All-Reduce processing in Example 3. FIG. 28 illustrates one of the combinations of transfer pairs whose minimum communication bandwidth min (Wm, n) among the transfer pairs is maximum among the selectable combinations of transfer pairs in step 2, in the case where the combination of transfer pairs in step 1 of the All-Reduce processing is the combination of transfer pairs illustrated in FIG. 27.

FIG. 28 illustrates GPU #0 and GPU #3, GPU #1 and GPU #2, GPU #4 and GPU #7, and GPU #5 and GPU #6 as the combination of transfer pairs whose minimum communication bandwidth min (Wm, n) among the transfer pairs is maximum. Since the connection bandwidth information between any transfer pair is 8, the minimum communication bandwidth min (Wm, n) among the transfer pairs in step 2 illustrated in FIG. 28 is 8.

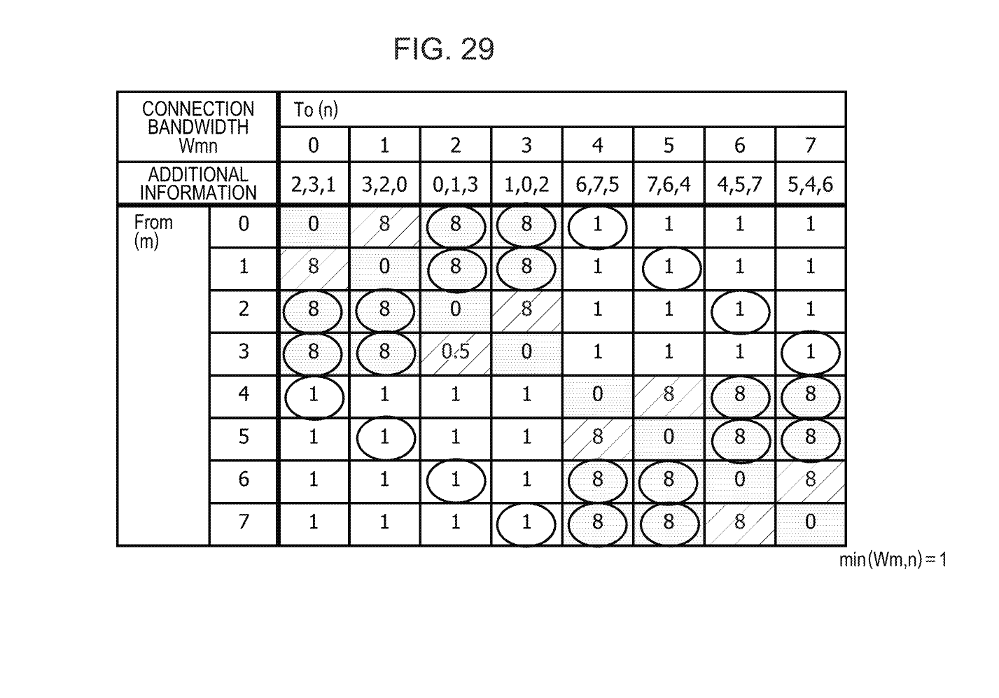

FIG. 29 is a diagram illustrating an example of a combination of transfer pairs in step 3 of the All-Reduce processing in Example 3. FIG. 29 illustrates one of the combinations of transfer pairs whose minimum communication bandwidth min (Wm, n) among the transfer pairs is maximum among the selectable combinations of transfer pairs in step 3, in the case where the combinations of transfer pairs in step 1 and step 2 of the All-Reduce processing are the combinations of transfer pairs illustrated in FIGS. 27 and 28, respectively.

FIG. 29 illustrates GPU #0 and GPU #4, GPU #1 and GPU #5, GPU #2 and GPU #6, and GPU #3 and GPU #7 as the combination of transfer pairs whose minimum communication bandwidth min (Wm, n) among the transfer pairs is maximum. Since the communication bandwidth between any transfer pair is 1, the minimum communication bandwidth min (Wm, n) among the transfer pairs in step 3 illustrated in FIG. 29 is 1.

Similarly to Example 1, in Example 3, the number of GPUs is 8, thus in the case of the Butterfly method, all the steps of the All-Reduce processing are completed in step 3. In the case of the Halving/Doubling method, since the number of GPUs is 8, the processing continues to step 6. Also, in Example 3, it is assumed that the combination of transfer pairs in each step of the sharing processing using the Halving/Doubling method is the same as a combination of transfer pairs in each step in the reverse order of the aggregation processing.

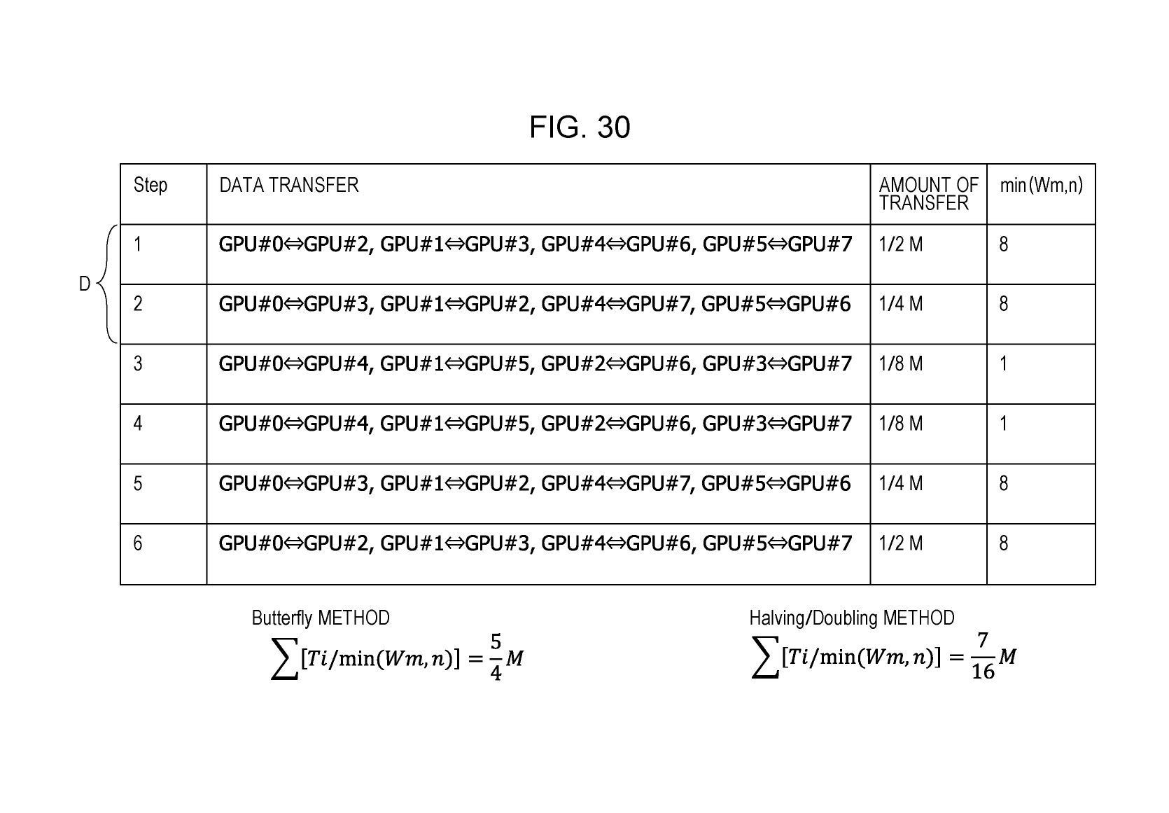

FIG. 30 is a diagram illustrating an example of combinations of transfer pairs in the Halving/Doubling method in Example 3. In the example illustrated in FIG. 30, the combination of transfer pairs in each of steps 1 to 3 (aggregation processing) is a combination of transfer pairs in which a minimum communication bandwidth min (Wm, n) among the transfer pairs is maximum in each step illustrated in FIGS. 27 to 29. In the example illustrated in FIG. 30, similarly to steps 3 to 1, the combination of transfer pairs in each of steps 4 to 6 (aggregation processing) a combination of transfer pairs whose minimum communication bandwidth min (Wm, n) among the transfer pairs is maximum in each step illustrated in FIG. 27 to FIG. 29.

In the case of the combinations of transfer pairs using the Halving/Doubling method illustrated in FIG. 30, the time cost is 7/16×M. In the case of the Butterfly method, the combinations of transfer pairs in steps 1 to 3 illustrated in FIG. 30 are obtained, the transfer amount information Ti in each step is M, and thus the time cost is 5/4×M.

Thus, for the case of the combinations of transfer pairs illustrated in FIG. 30, the Halving/Doubling method with less time cost is selected. Although Example 3 and Example 1 have the same system configuration, it might be expected that the communication bandwidth from GPU #3 to GPU #2 is reduced, thus the combinations of transfer pairs used in Example 3 (the combinations of transfer pairs of FIG. 30) are different from the combinations used in Example 1 (the combinations of transfer pairs of FIG. 16).

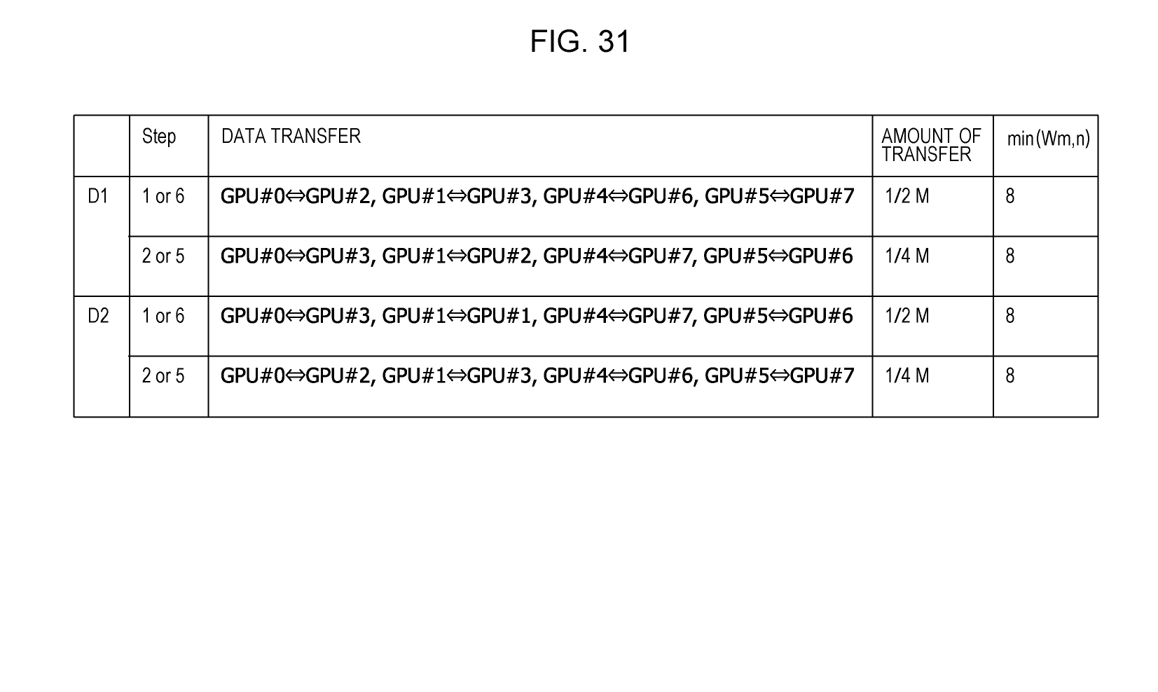

FIG. 31 is a diagram illustrating an example of variation in the combination of transfer pairs in each of step 1 and step 2 illustrated in FIG. 30. The combinations of transfer pairs in step 1 and step 2 of D1 illustrated in FIG. 31 are the same combinations of transfer pairs as in step 1 and step 2 illustrated in FIG. 30, respectively.

The combinations of transfer pairs in step 1 and step 2 of D2 illustrated in FIG. 31 have the same values of the transfer amount information Ti and the minimum communication bandwidth min (Wm, n) among the transfer pairs as the combinations of transfer pairs in step 1 and step 2 of D1. In other words, in FIG. 30, the combinations of transfer pairs in step 1 and step 2 may be the combinations of transfer pairs in step 1 and step 2 of D2 illustrated in FIG. 31. Also, when multiple combinations are selected, the combinations of transfer pairs in step 1 and step 2 of D2 illustrated in FIG. 31 may also be selected as the combinations of transfer pairs in step 1 and step 2.

The variation in the combination of transfer pairs in step 3 of FIG. 30 is the same as the combinations of transfer pairs illustrated in FIG. 18 of Example 1.

In the case of the Halving/Doubling method, the combination of transfer pairs in step 4 of FIG. 30 may be the combination of transfer pairs in one of B2 to B4 of FIG. 18. In the case of the Halving/Doubling method, the combinations of transfer pairs in step 5 and step 6 of FIG. 30 may be the combinations of transfer pairs in step 2 and step 1 of D2 illustrated in FIG. 31.

<Operation Effect of First Embodiment>

In the first embodiment, from algorithms for the All-Reduce processing and the combinations of transfer pairs in the respective steps of the algorithms, an algorithm for which it takes a shorter time for the All-Reduce processing and the combination of transfer pairs in each step of the algorithm are selected. Consequently, it is possible to reduce the time taken for the All-Reduce processing in the deep learning system 100.

Also, in the first embodiment, each time learning processing is performed, the connection bandwidth information between the GPUs is acquired. Thus, when a fault occurs in the connection between partial GPUs and a bandwidth between the partial GPUs is reduced, a combination of transfer pairs not including the partial GPUs is selected in each step of the All-Reduce processing (see, for instance, Example 3). Therefore, according to the first embodiment, even when a fault occurs in the connection between GPUs, it is possible to select an algorithm for which it takes a shorter time for the All-Reduce processing and the combination of transfer pairs in each step of the algorithm.

Also, in the first embodiment, combinations of transfer pairs are selected based on, for instance, a time cost which is calculated from the amount of data transfer and the communication bandwidth between GPUs. Also, the time cost in each step is calculated using the communication bandwidth of a transfer pair having a least communication bandwidth. Therefore, a combination of transfer pair selected in each step is such a combination of transfer pairs whose minimum communication bandwidth is maximum among the selectable combinations of transfer pairs. Therefore, according to the first embodiment, an algorithm for which it takes the shortest time for the All-Reduce processing and combinations of transfer pairs in each step of the algorithm are selected.

In the first embodiment, multiple combinations of transfer pairs may be selected. By selecting the multiple combinations of transfer pairs and notifying each node 1 of the combinations, even when the All-Reduce processing performed according to a combination of one transfer pair is failed, All-Reduce processing may be immediately performed using another combination of transfer pair without performing the transfer pair determination processing again.

Note that the acquisition processing (see FIG. 8) for connection bandwidth information between GPUs according to the first embodiment does not have to be performed as part of learning processing, and may be performed, for instance, periodically or performed in accordance with instructions input from an administrator of the deep learning system 100.

In the first embodiment, the CPU 11 of any one node 1 in the deep learning system 100 performs the transfer pair determination processing (see FIG. 9). However, without being limited to this, for instance, multiple nodes 1 in the deep learning system 100 may perform the transfer pair determination processing, and may exchange All-Reduce processing selected by the nodes 1 and the combination of transfer pairs in each step. Alternatively, a control device that controls all nodes 1 in the deep learning system 100 may perform the acquisition processing for connection bandwidth information and the transfer pair determination processing, and may notify each node 1 of an algorithm for the All-Reduce processing and the combination of transfer pairs in each step.

In the first embodiment, all GPUs 13 present in the deep learning system 100 are to perform deep learning, and to undergo the All-Reduce processing. However, without being limited to this, for instance, partial GPUs 13 present in the deep learning system 100 may be to perform deep learning and to undergo the All-Reduce processing. In this case, in the transfer pair determination processing, the combinations of transfer pairs are determined in the partial GPUs 13 that are to undergo the All-Reduce processing.

<First Modification>

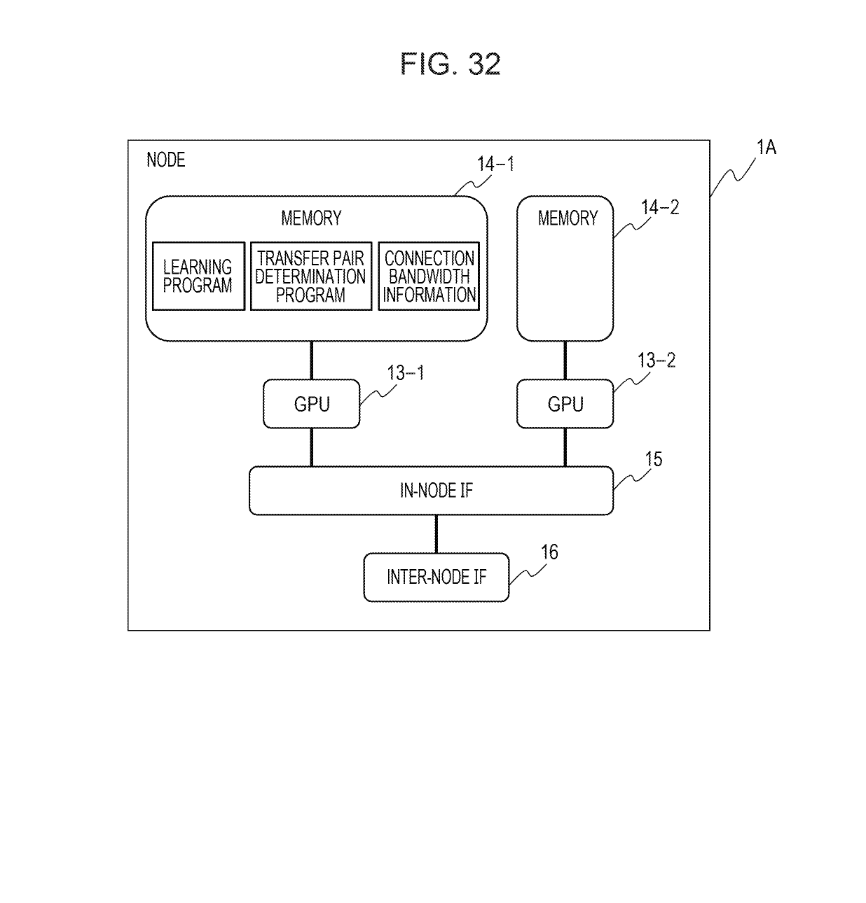

FIG. 32 is a diagram illustrating an example of hardware configuration of nodes according to a first modification. A node 1A according to the modification include no CPU. The node 1A includes multiple GPUs 13, multiple memories 14 for the GPUs 13, an in-node IF15, and an inter-node IF16. In the node 1A, one of the multiples GPUs 13 performs the processing of the CPU 11 according to the first embodiment. In the modification, a GPU 13 that performs the processing of the CPU 11 according to the first embodiment is an example of the “control unit”.

In FIG. 32, GPU 13-1 performs the processing of the CPU 11 according to the first embodiment. Therefore, a memory 14-1 for the GPU 13-1 stores a learning program, a transfer pair determination program, and connection bandwidth information.

The GPU 13-1 performs, for instance, the processing illustrated in FIGS. 7 to 10 by executing the learning program. For example, the GPU 13-1 acquires connection bandwidth information between the GPUs present in the deep learning system 100, determines an algorithm for the All-Reduce processing and a combination of transfer pairs in each step, and controls the learning processing.

<Second Modification>

In a second modification, k combinations of transfer pairs (k is an integer greater than or equal to 2) are selected, the gradient information on each GPU is divided into h pieces (h is a positive integer≤k), a child process is created for each of h subdivided gradient information, and All-Reduce processing is performed in parallel by using a different combination of transfer pairs for each child process.

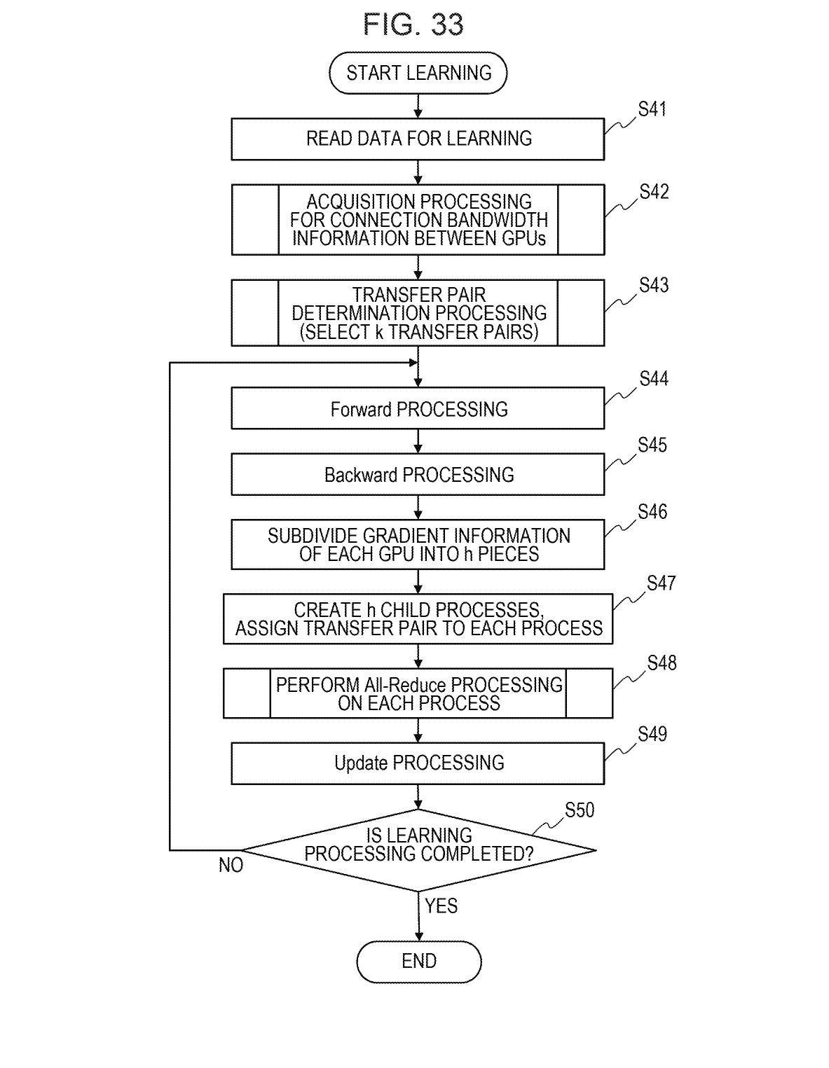

FIG. 33 is an example flowchart of learning processing of deep learning in the node 1 according to the second modification. The processing illustrated in FIG. 33 is to be performed in the second modification instead of the processing of FIG. 7 in the first embodiment. The processing illustrated in FIG. 33 is achieved, for instance, by the CPU 11 of the node 1 executing the learning program. The processing illustrated in FIG. 33 is to be performed by each node 1 in the deep learning system 100.

The processing illustrated in FIG. 33 is started, for instance, by input of an instruction to start learning. An instruction to start learning is inputted by an administrator of the deep learning system 100, for instance, via a control device that controls all nodes 1 in the deep learning system 100 or via one of the nodes 1.

The processing in S41 to S45 is the same as the processing in S1 to S5 of FIG. 7. The CPU 11 reads data for learning (S41), performs the acquisition processing for connection bandwidth information between the GPUs 13 (S42), and performs the transfer pair determination processing (S43). The transfer pair determination processing is performed by any one of the nodes 1. However, in the second modification, the CPU 11 of the node 1, which performs the transfer pair determination processing, selects k combinations of transfer pairs including a first combination of transfer pairs having the lowest time cost, based on the time cost. Methods of selecting k combinations of transfer pairs include, for instance, the method of selecting k combinations with kth lowest time cost, and the method of selecting k combinations from the combinations of transfer pairs each having a time cost less than or equal to the lowest time cost+α, where the lowest time cost is obtained from the first combination of transfer pairs.

Subsequently, the CPU 11 starts learning processing of each GPU 13, and each GPU 13 sequentially performs the forward processing, and the backward processing in all the neuron layers (S44, S45).

Subsequently, the CPU 11 instructs each GPU 13 to divide the gradient information into h pieces for subdivision (S46). The CPU 11 creates h child processes, and assigns one of the subdivided pieces of the gradient information and one of the k combinations of transfer pairs to each process so that no overlap occurs, for instance (S47). For instance, the method of dividing the gradient information, and the method of assigning each of the subdivided pieces of the gradient information to a combination of transfer pairs are in common between all the nodes 1, and a combination of transfer pairs assigned to a subdivided piece at the same position among the subdivided pieces of the gradient information do match among all the nodes 1. Also, combinations of transfer pairs assigned to part of the h child processes may overlap.

Subsequently, the All-Reduce processing is performed in each of the h child processes (S48). The details of the All-Reduce processing of each child process are as illustrated in FIG. 10. When all the h child processes are completed, all gradient information calculated by the GPUs 13 is shared among all the GPUs 13 in the deep learning system 100.

Subsequently, each GPU 13 performs the update processing (S49). Subsequently, each GPU 13 determines whether or not repetition of learning processing is ended (S50). When repetition of the learning processing is determined not to be ended (NO in S50), the processing returns to S4. When repetition of the learning processing is determined to be ended (YES in S50), the processing illustrated in FIG. 33 is ended.

In the second modification, the gradient information on each GPU 13 is subdivided, processes are performed in parallel in different combinations of transfer pairs for the subdivided pieces of the gradient information, thereby making it possible to reduce the number of unused communication paths between the GPUs 13 and to improve effective use. In addition, the data size handled by a process of the All-Reduce processing is reduced, and thus high-speed All-Reduce processing may be achieved.

<Recording Medium>

A program to cause computers and other machines, devices (hereinafter, a computer) to implement one of the above-mentioned functions may be recorded on a computer-readable recording medium. The function may be provided by causing a computer to read and execute the program in the recording medium.

Here, the computer-readable recording medium refers to a recording medium that is capable of storing information such as data and programs electrically, magnetically, optically, mechanically, or by chemical functioning, and of reading the information from a computer. Media detachable from a computer among such recording media include, for instance, a flexible disk, a magneto-optical disc, a compact disc (CD), read only memory (ROM), CD-Recordable (R), a digital versatile disk (DVD), a Blu-ray Disc, a digital audio tape (DAT), 8-mm tape, and a memory card such as a flash memory. Also, recording media fixed to a computer include a hard disk, and a read only memory (ROM). In addition, a solid state drive (SSD) may be utilized as a recording medium detachable from a computer and as a recording medium fixed to a computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A system comprising:
a plurality of information processing devices each including a group of arithmetic processors, the plurality of information processing devices being configured to perform parallel processing by using calculation result data of the groups of arithmetic processors included in the plurality of information processing devices, wherein
at least one of the plurality of information processing devices includes:
a memory configured to store bandwidth information indicating a communication bandwidth with which an arithmetic processor included in the groups of arithmetic processors communicates with another arithmetic processor included in the groups of arithmetic processors, and
a processor coupled to the memory and configured to, for a source arithmetic processor that is any one of the groups of arithmetic processors, determines a destination arithmetic processor that is one of the groups of arithmetic processors to which the calculation result data of the source arithmetic processor is to be transferred, based on the bandwidth information stored in the memory.

2. The system of claim 1, wherein
the processor determines the destination arithmetic processor so as to reduce a first time taken for the calculation result data of each of the groups of arithmetic processors to be shared among the groups of arithmetic processors.

3. The system of claim 2, wherein:
a step is defined as transfer of the calculation result data, whose data volume is determined according to a predetermined algorithm, between each pair of arithmetic processors among part or all of the groups of arithmetic processors; and
the processor is configured to:
obtain a number of the steps taken for the calculation result data of each of the groups of arithmetic processors to be shared among the groups of arithmetic processors, and obtain a transfer data amount in each of the steps,
determine, for each of the steps, a set of source-destination patterns each indicating a combination of the source arithmetic processors and the destination arithmetic processors,
calculate, for each of a plurality of source-destination pattern combinations, the first time, based on the bandwidth information and the transfer data amount in each of the steps, each of the plurality of source-destination pattern combinations being a combination of source-destination patterns that are respectively selected from the sets of source-destination patterns determined for the respective steps, and
select at least one source-destination pattern combination for which the calculated first time is shortest, from the plurality of source-destination pattern combinations.

4. The system of claim 3, wherein
for calculation of the first time in each of the plurality of source-destination pattern combinations, the processor uses a minimum communication bandwidth that is smallest one of communication bandwidths between arithmetic processors in each of the steps.

5. The system of claim 3, wherein
in determination of the set of source-destination patterns, the processor determines, for each of the steps and for each of a plurality of data-sharing algorithms, the set of source-destination patterns with which the calculation result data is transferred in the part or all of the plurality of arithmetic processors.

6. The system of claim 5, wherein:
each of the groups of arithmetic processors included in the plurality of information processing devices is used for learning processing to learn weight coefficients in a predetermined neural network; and
each of the groups of arithmetic processors divides the calculation result data into a predetermined number of subdivided pieces in All-Reduced processing in the learning processing, assigns one of the set of source-destination patterns to each of the subdivided pieces of the calculation result data, and transmits the subdivided pieces of the calculation result data to the destination arithmetic processors, in parallel, based on the assigned source-destination patterns.

7. The system of claim 1, wherein:
each of the groups of arithmetic processors included in the plurality of information processing devices is used for learning processing to learn weight coefficients in a predetermined neural network; and
the processor obtains the bandwidth information before the learning processing to learn the weight coefficients is performed, and determines the destination arithmetic processor, based on the obtained bandwidth information.

8. An apparatus that serves as at least one of a plurality of information processing devices each including a group of arithmetic processors, the plurality of information processing devices being configured to perform parallel processing by using calculation result data of the groups of arithmetic processors included in the plurality of information processing devices, the apparatus comprising:
a memory configured to store bandwidth information indicating a communication bandwidth with which an arithmetic processor included in the groups of arithmetic processors communicate with another arithmetic processor included in the groups of arithmetic processors, and
a processor coupled to the memory and configured to, for a source arithmetic processor that is any one of the groups of arithmetic processors, determines a destination arithmetic processor that is one of the groups of arithmetic processors to which the calculation result data of the source arithmetic processor is to be transferred, based on the bandwidth information stored in the memory.

9. A method performed by at least one of a plurality of information processing devices each including a group of arithmetic processors, the plurality of information processing devices being configured to perform parallel processing by using calculation result data of the groups of arithmetic processors included in the plurality of information processing devices, the method comprising:
providing a memory with bandwidth information indicating a communication bandwidth with which an arithmetic processor included in the groups of arithmetic processors communicate with another arithmetic processor included in the groups of arithmetic processors; and
for a source arithmetic processor that is any one of the groups of arithmetic processors, determining a destination arithmetic processor that is one of the groups of arithmetic processors to which the calculation result data of the source arithmetic processor is to be transferred, based on the bandwidth information stored in the memory.
